(19) United States
(12) Patent Application Publication
(10) Pub. No.: US 2025/0380157 A1
(43) Pub. Date: Dec. 11, 2025

(54) MACHINE LEARNING MODEL MONITORING IN ACCORDANCE WITH CONSISTENCY CONSTRAINTS

(71) Applicant: QUALCOMM Incorporated, San Diego, CA (US)

(72) Inventors: Mohamed Fouad Ahmed MARZBAN, San Diego, CA (US); Wooseok NAM, San Diego, CA (US); Tao LUO, San Diego, CA (US)

(21) Appl. No.: 18/737,783

(22) Filed: Jun. 7, 2024

(51) Int. Cl. H04W 24/02; G06N 3/08

(52) U.S. Cl. CPC H04W 24/02; G06N 3/08

(57) ABSTRACT

Methods, systems, and devices for wireless communications are described. A device, such as a user equipment (UE) or a network entity may support consistency constraints across inference and training information associated with a machine learning (ML) model. The device may obtain a set of consistency constraints associated with monitoring the ML model, the ML model associated with a set of training information including first data instances. The set of consistency constraints may be associated with the first data instances within the set of training information and second data instances within a set of inference information being in accordance with consistent parameter values. The device may monitor the ML model in response to the first data instances and the second data instances satisfying the set of consistency constraints. The device may perform the wireless communications in accordance with monitoring the ML model.

### FIELD OF TECHNOLOGY

The following relates to wireless communications, including machine learning (ML) model monitoring in accordance with consistency constraints.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications devices may support or implement an artificial intelligence (AI) or machine learning (ML) model. In some cases, a wireless communications device may monitor a ML model, such as for data drift or concept drift detection.

### SUMMARY

The systems, methods, and devices of this disclosure each have several innovative aspects, no single one of which is solely responsible for the desirable attributes disclosed herein.

ML models may be trained with input information prior to deployment of a wireless communication device in a wireless communications system. In examples in which the wireless communication device is operating in conditions which are different from training conditions used to train a ML model, the ML model may be inapplicable to the actual conditions the wireless communication device is operating in. When a ML model loses effectiveness or is inapplicable to a current scenario of the wireless communication device, this may be referred to as data “drift.” In such examples, inputs to the ML model may not provide accurate inferences based on the differences between the actual conditions of the wireless communication device and the conditions used to train the ML models. A wireless communication device may detect data drift by monitoring the ML model, such as by monitoring based on a multi-dimensional distribution or based on comparing inputs to the model to one or more sets of training data. However, monitoring the ML model may not address or account for consistency of the inputs, outputs, or both of the ML model. For example, the ML model may use inconsistent training data, inference data, or both. Using data having different measurement parameters, including intervals at which measurements are performed, a quantity of measurements performed per instance, or the like, may be susceptible to inaccurate identification of instances of data drift (e.g., false positives or other erroneous results).

Accordingly, as described herein, the wireless communication device may ensure that one or more consistency constraints for the training data and the inference data are satisfied before monitoring for data drift (e.g., may monitor for data drift if the one or more consistency constraints are satisfied, may refrain from monitoring for data drift if the one or more consistency constraints are not satisfied). For example, the wireless communication device may obtain consistency constraints associated with inference and training data, and the wireless communication device may monitor the ML model based on the obtained consistency constraints being satisfied.

A method for wireless communications by a first device is described. The method may include obtaining a set of consistency constraints associated with monitoring a machine learning (ML) model, the ML model associated with a set of training information including a first set of multiple data instances, where the set of consistency constraints are associated with the first set of multiple data instances within the set of training information and a second set of multiple data instances within a set of inference information being in accordance with consistent parameter values, monitoring the ML model in response to the first set of multiple data instances and the second set of multiple data instances satisfying the set of consistency constraints, and performing the wireless communications in accordance with monitoring the ML model.

A first device for wireless communications is described. The first device may include one or more memories storing processor executable code, and one or more processors coupled with the one or more memories. The one or more processors may individually or collectively be operable to execute the code to cause the first device to obtain a set of consistency constraints associated with monitoring a ML model, the ML model associated with a set of training information including a first set of multiple data instances, where: the set of consistency constraints are associated with the first set of multiple data instances within the set of training information and a second set of multiple data instances within a set of inference information being in accordance with consistent parameter values, monitor the ML model in response to the first set of multiple data instances and the second set of multiple data instances satisfying the set of consistency constraints, and perform the wireless communications in accordance with monitoring the ML model.

Another first device for wireless communications is described. The first device may include means for obtaining a set of consistency constraints associated with monitoring a ML model, the ML model associated with a set of training information including a first set of multiple data instances, where: the set of consistency constraints are associated with the first set of multiple data instances within the set of training information and a second set of multiple data instances within a set of inference information being in accordance with consistent parameter values, means for monitoring the ML model in response to the first set of multiple data instances and the second set of multiple data instances satisfying the set of consistency constraints, and means for performing the wireless communications in accordance with monitoring the ML model.

A non-transitory computer-readable medium storing code for wireless communications is described. The code may include instructions executable by one or more processors to obtain a set of consistency constraints associated with monitoring a ML model, the ML model associated with a set of training information including a first set of multiple data instances, where: the set of consistency constraints are associated with the first set of multiple data instances within the set of training information and a second set of multiple data instances within a set of inference information being in accordance with consistent parameter values, monitor the ML model in response to the first set of multiple data instances and the second set of multiple data instances satisfying the set of consistency constraints, and perform the wireless communications in accordance with monitoring the ML model.

In some examples of the method, first devices, and non-transitory computer-readable medium described herein, the set of consistency constraints includes a distribution dimension consistency constraint associated with a quantity of measurements per data instance, and where the first set of multiple data instances and the second set of multiple data instances satisfying the distribution dimension consistency constraint includes and data instances within the first set of multiple data instances including a first quantity of measurements; and data instances within the second set of multiple data instances including the first quantity of measurements or a second quantity of measurements that may be within a threshold of the first quantity of measurements.

In some examples of the method, first devices, and non-transitory computer-readable medium described herein, the set of consistency constraints includes a resource separation consistency constraint associated with a separation within a domain between measurements included in respective data instances, where the domain includes a time domain, a frequency domain, a beam direction domain, or any combination thereof, and where the first set of multiple data instances and the second set of multiple data instances satisfying the resource separation consistency constraint includes and data instances within the first set of multiple data instances including measurements that may be separated according to a first separation within the domain; and data instances within the second set of multiple data instances including measurements that may be separated according to the first separation or a second separation within the domain that may be within a threshold of the first separation.

Some examples of the method, first devices, and non-transitory computer-readable medium described herein may further include operations, features, means, or instructions for obtaining one or more messages indicative of a set of measurement resources to be used by the first device for measurements included in the second set of multiple data instances, where the set of measurement resources may be in accordance with the resource separation consistency constraint.

In some examples of the method, first devices, and non-transitory computer-readable medium described herein, the set of consistency constraints includes a measurement resource consistency constraint associated with a type of reference signal used for measurements included in respective data instances, and where the first set of multiple data instances and the second set of multiple data instances satisfying the measurement resource consistency constraint includes and a same type of reference signal being used for measurements included in data instances within the first set of multiple data instances and for measurements included in data instances within the second set of multiple data instances.

In some examples of the method, first devices, and non-transitory computer-readable medium described herein, the set of consistency constraints include an energy per resource element (EPRE) consistency constraint associated with an EPRE ratio between reference signals used for measurements included in respective data instances, and where the first set of multiple data instances and the second set of multiple data instances satisfying the EPRE consistency constraint includes and first reference signals for measurements included in data instances within the first set of multiple data instances and second reference signals for measurements included in data instances within the second set of multiple data instances being in accordance with the EPRE ratio.

Some examples of the method, first devices, and non-transitory computer-readable medium described herein may further include operations, features, means, or instructions for communicating one or more messages indicative of a set of measurement resources to be used by the first device for measurements associated with the second set of multiple data instances, where the set of measurement resources may be in accordance with the set of consistency constraints.

In some examples of the method, first devices, and non-transitory computer-readable medium described herein, obtaining the set of consistency constraints may include operations, features, means, or instructions for receiving one or more messages indicative of the set of consistency constraints.

In some examples of the method, first devices, and non-transitory computer-readable medium described herein, obtaining the set of consistency constraints may include operations, features, means, or instructions for obtaining a resource configuration associated with a quantity of measurements per data instance, a separation between measurements of data instances, a reference signal type, an EPRE ratio, or any combination thereof and identifying the set of consistency constraints in accordance with the resource configuration.

In some examples of the method, first devices, and non-transitory computer-readable medium described herein, the resource configuration includes a field that indicates that the resource configuration may be indicative of the set of consistency constraints.

In some examples of the method, first devices, and non-transitory computer-readable medium described herein, obtaining the set of consistency constraints may include operations, features, means, or instructions for obtaining the set of consistency constraints in accordance with an association between the set of consistency constraints and a functionality of the one or more functionalities, the identifier, or both.

In some examples of the method, first devices, and non-transitory computer-readable medium described herein, obtaining the set of consistency constraints may include operations, features, means, or instructions for outputting a capability message indicating a capability of the first device to support one or more consistency constraints and obtaining the set of consistency constraints in accordance with the capability of the first device.

Some examples of the method, first devices, and non-transitory computer-readable medium described herein may further include operations, features, means, or instructions for outputting a recommendation associated with the set of consistency constraints, where the recommendation may be in accordance with the set of training information.

Some examples of the method, first devices, and non-transitory computer-readable medium described herein may further include operations, features, means, or instructions for outputting one or more messages indicative of the set of consistency constraints and obtaining, in response to the one or more messages indicative of the set of consistency constraints, the set of inference information, where monitoring the ML model may be in accordance with the set of inference information.

In some examples of the method, first devices, and non-transitory computer-readable medium described herein, monitoring the ML model may include operations, features, means, or instructions for monitoring the ML model using a subset of the first set of multiple data instances associated with the set of training information, where the subset of the first set of multiple data instances and the second set of multiple data instances satisfy the set of consistency constraints.

In some examples of the method, first devices, and non-transitory computer-readable medium described herein, the first set of multiple data instances and the second set of multiple data instances being in accordance with consistent parameter values may include operations, features, means, or instructions for the first set of multiple data instances being in accordance with one or more first parameter values; and the second set of multiple data instances being in accordance with one or more second parameter values, where each of the one or more first parameter values and the one or more second parameter values may be within a corresponding range, each of the one or more first parameter values may be within a threshold of a corresponding second parameter value from among the one or more second parameter values, or any combination thereof.

In some examples of the method, first devices, and non-transitory computer-readable medium described herein, monitoring the ML model may include operations, features, means, or instructions for determining a similarity between the set of training information and the set of inference information.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports machine learning (ML) model monitoring in accordance with consistency constraints in accordance with one or more aspects of the present disclosure.

FIG. 2 shows an illustrative block diagram of an example ML model that supports ML model monitoring in accordance with consistency constraints in accordance with one or more aspects of the present disclosure.

FIG. 3 shows an illustrative block diagram of an example ML architecture that supports ML model monitoring in accordance with consistency constraints in accordance with one or more aspects of the present disclosure.

FIG. 4 shows an example of a wireless communications system that supports ML model monitoring in accordance with consistency constraints in accordance with one or more aspects of the present disclosure.

FIG. 5 through 7 show examples of process flows that support ML model monitoring in accordance with consistency constraints in accordance with one or more aspects of the present disclosure.

FIGS. 8 and 9 show block diagrams of devices that support ML model monitoring in accordance with consistency constraints in accordance with one or more aspects of the present disclosure.

FIG. 10 shows a block diagram of a communications manager that supports ML model monitoring in accordance with consistency constraints in accordance with one or more aspects of the present disclosure.

FIG. 11 shows a diagram of a system including a device that supports ML model monitoring in accordance with consistency constraints in accordance with one or more aspects of the present disclosure.

FIGS. 12 and 13 show flowcharts illustrating methods that support ML model monitoring in accordance with consistency constraints in accordance with one or more aspects of the present disclosure.

### DETAILED DESCRIPTION

A wireless device, such as a user equipment (UE) or a network entity, may use artificial intelligence (AI) and machine learning (ML) to perform inferences for wireless communication. For example, a wireless communication device may be configured with ML models, and the wireless communication device may use the ML models for beam prediction, positioning inferences, and the like. The ML models may be trained with input information prior to deployment of the wireless communication device in a wireless communications system. For example, the wireless communication device may be configured with training input information to perform inferences and train the ML models, and may also obtain training measurement information (e.g., actual results from the training input information) to compare to the inferences. In examples in which the wireless communication device is operating in conditions which are different from training conditions used to train a ML model, the ML model may be inapplicable to the actual conditions the wireless communication device is operating in. When a ML model loses effectiveness or is inapplicable to a current scenario of the wireless communication device, this may be referred to as data “drift.” In such examples, inputs to the ML model may not provide accurate inferences based on the differences between the actual conditions of the wireless communication device and the conditions used to train the ML models.

A wireless communication device may detect data drift by monitoring the ML model, such as by monitoring based on a multi-dimensional distribution or based on comparing inputs to the model to one or more sets of training data. However, monitoring the ML model may not address or account for consistency of the inputs, outputs, or both of the ML model. For example, the ML model may use inconsistent training data, inference data, or both. Using data having different measurement parameters, including intervals at which measurements are performed, a quantity of measurements performed per instance, or the like, may be susceptible to inaccurate identification of instances of data drift (e.g., false positives or other erroneous results). Accordingly, as described herein, the wireless communication device may ensure that one or more consistency constraints for the training data and the inference data are satisfied before monitoring for data drift (e.g., may monitor for data drift if the one or more consistency constraints are satisfied, may refrain from monitoring for data drift if the one or more consistency constraints are not satisfied).

For example, the wireless communication device may obtain consistency constraints associated with inference and training data. The wireless communication device may monitor the ML model based on the obtained consistency constraints being satisfied. That is, the wireless communication device may monitor the ML model in accordance with the inference data and the training data being consistent relative to each other. The consistency constraints may be associated with a format of measurements, including a quantity of measurements per measurement instance, resources used for each measurement instance or across measurement instances, a type of reference signal measurements, or the like. In examples in which the wireless communication device is a UE, the UE may recommend one or more consistency constraints and receive an indication of consistency constraints from a network entity, where the UE obtains the inference data according to the consistency constraints. Alternatively, in examples in which the wireless communication device is a network entity, the network entity may configure the consistency constraints at the UE, and the UE may report inference data satisfying the consistency constraints to the network entity.

Aspects of the disclosure are initially described in the context of wireless communications systems. Aspects of the disclosure are also described in the context of example ML architectures, example ML models, and process flows. Aspects of the disclosure are further illustrated by and described with reference to apparatus diagrams, system diagrams, and flowcharts that relate to ML model monitoring in accordance with consistency constraints.

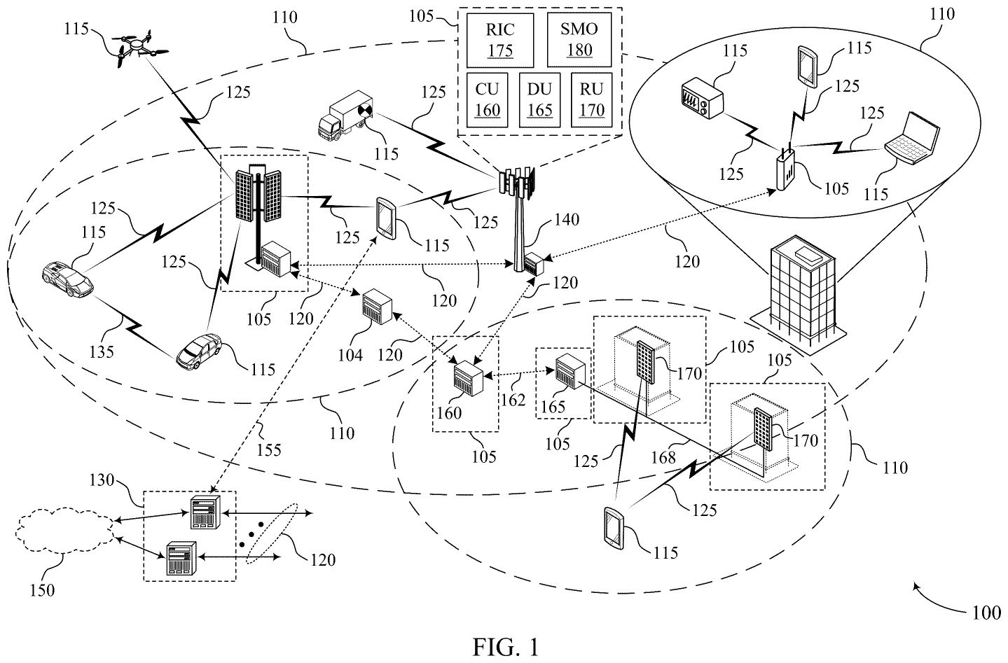

FIG. 1 shows an example of a wireless communications system 100 that supports ML model monitoring in accordance with consistency constraints in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate information (e.g., transmit information, receive information, or both) via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

A device, such as the UE 115 or the network entity 105 may support consistency constraints across inference and training information associated with a ML model. The device may obtain a set of consistency constraints associated with monitoring the ML model, the ML model associated with a set of training information including first data instances. The set of consistency constraints may be associated with the first data instances within the set of training information and second data instances within a set of inference information being in accordance with consistent parameter values. The device may monitor the ML model in response to the first data instances and the second data instances satisfying the set of consistency constraints. The device may perform the wireless communications in accordance with monitoring the ML model.

Certain aspects and techniques as described herein may be implemented, at least in part, using an AI program, such as a program that includes a ML or artificial neural network (ANN) model. An example ML model may include mathematical representations or define computing capabilities for making inferences from input data based on patterns or relationships identified in the input data. As used herein, the term “inferences” can include one or more of decisions, predictions, determinations, or values, which may represent outputs of the ML model. The computing capabilities may be defined in terms of certain parameters of the ML model, such as weights and biases. Weights may indicate relationships between certain input data and certain outputs of the ML model, and biases are offsets which may indicate a starting point for outputs of the ML model. An example ML model operating on input data may start at an initial output based on the biases and then update its output based on a combination of the input data and the weights.

ML models may be deployed in one or more devices (e.g., the network entity 105 or UE 115) and may be configured to enhance various aspects of a wireless communication system. For example, an ML model may be trained to identify patterns or relationships in data corresponding to a network, a device, an air interface, or the like. An ML model may support operational decisions relating to one or more aspects associated with wireless communications devices, networks, or services. For example, an ML model may be utilized for supporting or improving aspects such as signal coding/decoding, network routing, energy conservation, transceiver circuitry controls, frequency synchronization, timing synchronization channel state estimation, channel equalization, channel state feedback, modulation, demodulation, device positioning, beamforming, load balancing, operations and management functions, security, etc.

ML models may be characterized in terms of types of learning that generate specific types of learned models that perform specific types of tasks. For example, different types of ML include supervised learning, unsupervised learning, semi-supervised learning, reinforcement learning, etc. ML models may be used to perform different tasks such as classification or regression, where classification refers to determining one or more discrete output values from a set of predefined output values, and regression refers to determining continuous values which are not bounded by predefined output values. Some example ML models configured for performing such tasks include ANNs such as convolutional neural networks (CNNs) and recurrent neural networks (RNNs), transformers, diffusion models, regression analysis models (such as statistical models), large language models (LLMs), decision tree learning (such as predictive models), support vector networks (SVMs), and probabilistic graphical models (such as a Bayesian network), etc.

The description herein illustrates, by way of some examples, how one or more tasks or problems in wireless communications may benefit from the application of one or more ML models, including beam management operations, such as beam prediction. To facilitate the discussion, an ML model configured using an ANN is used, but it should be understood, that other types of ML models may be used instead of an ANN. Hence, unless expressly recited, subject matter regarding an ML model is not necessarily intended to be limited to an ANN solution. Further, it should be understood that, unless otherwise specifically stated, terms such “AI/ML model,” “ML model,” “trained ML model,” “ANN,” “model,” “algorithm,” or the like are intended to be interchangeable.

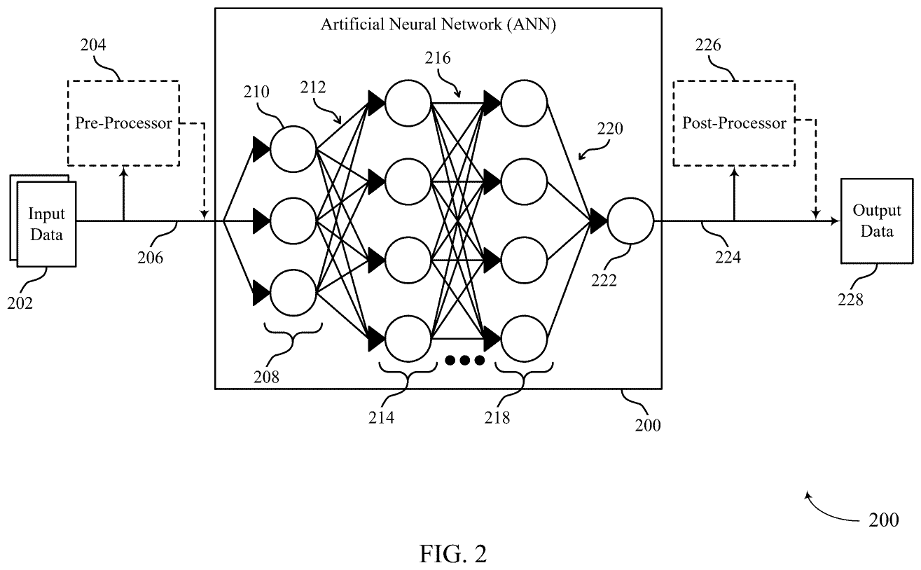

FIG. 2 shows an illustrative block diagram of an example ML model represented by an ANN 200.

ANN 200 may receive input data 206 which may include one or more bits of data 202, pre-processed data output from pre-processor 204 (optional), or some combination thereof. Here, data 202 may include training data, verification data, application-related data, or the like, based, for example, on the stage of deployment of ANN 200. Pre-processor 204 may be included within ANN 200 in some other implementations. Pre-processor 204 may, for example, process all or a portion of data 202 which may result in some of data 202 being changed, replaced, deleted, etc. In some implementations, pre-processor 204 may add additional data to data 202. In some implementations, the pre-processor 204 may be a ML model, such as an ANN. In some implementations described herein, the pre-processor 204 may support generation of data 202 satisfying a set of consistency constraints. For example, the pre-processor 204 may modify or remove a portion of the data to satisfy the consistency constraints. As an example, the pre-processor 204 may remove one or more data instances of multiple data instances of a set of training data, a set of inference data, or both based on the one or more data instances failing to satisfy the set of consistency constraints. In other words, the ANN 200 may receive a subset of training data, a subset of inference data, or both, where the subsets satisfy the consistency constraints.

ANN 200 includes at least one first layer 208 of artificial neurons 210 to process input data 206 and provide resulting first layer data via connections or “edges” such as edges 212 to at least a portion of at least one second layer 214. Second layer 214 processes data received via edges 212 and provides second layer output data via edges 216 to at least a portion of at least one third layer 218. Third layer 218 processes data received via edges 216 and provides third layer output data via edges 220 to at least a portion of a final layer 222 including one or more neurons to provide output data 224. All or part of output data 224 may be further processed in some manner by (optional) post-processor 226. Thus, in certain examples, ANN 200 may provide output data 228 that is based on output data 224, post-processed data output from post-processor 226, or some combination thereof.

Post-processor 226 may be included within ANN 200 in some other implementations. Post-processor 226 may, for example, process all or a portion of output data 224 which may result in output data 228 being different, at least in part, to output data 224, as result of data being changed, replaced, deleted, etc. In some implementations, post-processor 226 may be configured to add additional data to output data 224. In this example, second layer 214 and third layer 218 represent intermediate or hidden layers that may be arranged in a hierarchical or other like structure. Although not explicitly shown, there may be one or more further intermediate layers between the second layer 214 and the third layer 218. In some implementations, the post-processor 226 may be a ML model, such as an ANN.

The structure and training of artificial neurons 210 in the various layers may be tailored to specific requirements of an application. Within a given layer such as first layer 208, second layer 214, or third layer 218 of ANN 200, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to parameters such as the previously described weights and biases of ANN 200. The weights and biases of ANN 200 may be adjusted during a training process or during operation of ANN 200. The weights of the various artificial neurons may control a strength of connections between layers or artificial neurons, while the biases may control a direction of connections between the layers or artificial neurons. An activation function may select or determine whether an artificial neuron transmits its output to the next layer or not in response to its received data.

Different activation functions may be used to model different types of non-linear relationships. By introducing non-linearity into an ML model, an activation function allows the configuration for the ML model to change in response to identifying or detecting complex patterns and relationships in the input data 206. Some non-exhaustive example activation functions include a sigmoid based activation function, a hyperbolic tangent (tanh) based activation function, a convolutional activation function, up-sampling, pooling, and a rectified linear unit (ReLU) based activation function.

Training of an ML model, such as ANN 200, may be conducted using training data. Training data may include one or more datasets which ANN 200 may use to identify patterns or relationships. Training data may represent various types of information, including written, visual, audio, environmental context, operational properties, etc. During training, the parameters (such as the weights and biases) of artificial neurons 210 may be changed, such as to minimize or otherwise reduce a loss function or a cost function. A training process may be repeated multiple times to fine-tune the ANN 200 with each iteration.

ANN 200 or other ML models may be implemented in various types of processing circuits along with memory and applicable instructions therein. For example, general-purpose hardware circuits, such as, such as one or more central processing units (CPUs), one or more graphics processing units (GPUs), or suitable combinations thereof, may be employed to implement a model. In some implementations, one or more tensor processing units (TPUs), neural processing units (NPUs), or other special-purpose processors, field-programmable gate arrays (FPGAs), application-specific integrated circuits (ASICs), or the like may also be employed.

In example aspects, an ML model may be trained prior to, or at some point following, operation of the ML model, such as ANN 200, on input data. When training the ML model, information in the form of applicable training data may be gathered or otherwise created for use in training an ANN accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in a UE or other device in a wireless communication system, or one or more network entities, or aggregated from multiple sources (such as a UE and a network entity/entities, one or more other UEs, the Internet, or the like). In another example, training data may be generated or collected online, offline, or both online and offline by a UE, network entity, or other device(s), and all or part of such training data may be transferred or shared (in real or near-real time), such as through store and forward functions or the like. In some implementations described herein, model training may involve a set of training data which satisfies a set of consistency constraints. For example, a device including the ANN 200, such as a UE or a network entity, may input the set of training data or a portion of the training data (e.g., one or more data instances of the set of training data, a subset of the training data, etc.), where training data input to the ANN 200 satisfies the set of consistency constraints.

Offline training may refer to creating and using a static training dataset, such as, in a batched manner, whereas online training may refer to a real-time collection and use of training data. For example, an ML model at a network device (such as, a UE) may be trained or fine-tuned using online or offline training. For offline training, data collection and training can occur in an offline manner at the network side (such as, at a base station or other network entity) or at the UE side. For online training, the training of a UE-side ML model may be performed locally at the UE or by a server device (such as, a server hosted by a UE vendor) in a real-time or near-real-time manner based on data provided to the server device from the UE. In certain instances, all or part of the training data may be shared within in a wireless communication system, or even shared (or obtained from) outside of the wireless communication system.

Once an ANN has been configured by setting parameters, including weights and biases, from training data, the ANN's performance may be evaluated. In some scenarios, evaluation/verification tests may use a validation dataset, which may include data not in the training data, to compare the model's performance to baseline or other benchmark information. The ANN configuration may be further refined, for example, by changing its architecture, re-training it on the data, or using different optimization techniques, etc.

As part of a training process, parameters affecting the functioning of the artificial neurons and layers may be adjusted. For example, backpropagation techniques may be used to train an ANN by iteratively adjusting weights or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and biases as needed to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model. A “dropout” technique may be used to randomly drop out some of the artificial neurons from a model during a training process, for example, in order to reduce overfitting and potentially improve the generalization of the model. An “early stopping” technique may be used to stop an on-going training process early, such as when a performance of the model using a validation dataset starts to degrade.

Another example technique includes data augmentation to generate additional training data by applying transformations to all or part of the training information. A transfer learning technique may be used which involves using a pre-trained model as a starting point for training a new model, which may be useful when training data is limited or when there are multiple tasks that are related to each other. A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ANN is a “pruning” technique. A pruning technique, which may be performed during a training process or after a model has been trained, involves the removal of unnecessary or less necessary, or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored. Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain example implementations, pruning techniques also may be applied to training data, for example, to remove outliers. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. Some example training processes that may be used to train an ANN include supervised learning, unsupervised learning, semi-supervised learning, and reinforcement learning technique. With supervised learning, a model is trained on a labeled training dataset, wherein the input data is accompanied by a correct or otherwise acceptable output. With unsupervised learning, a model is trained on an unlabeled training dataset, such that the model will need to learn to identify patterns and relationships in the data without the explicit guidance of a labeled training dataset. With semi-supervised learning, a model is trained using some combination of supervised and unsupervised learning processes, for example, when the amount of labeled data is somewhat limited. With reinforcement learning, a model may learn from interactions with its operation/environment, such as in the form of feedback akin to rewards or penalties. Reinforcement learning may be particularly beneficial when used to improve or attempt to optimize a behavior of a model deployed in a dynamically changing environment, such as a wireless communication network.

Distributed, shared, or collaborative learning techniques may be used for the training process. For example, techniques such as federated learning may be used to decentralize the training process and rely on multiple devices, network entities, or organizations for training various versions or copies of a ML model, without relying on a centralized training mechanism. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ANN to be trained on data collected from a wide range of devices and environments. For example, an ANN may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a global or shared model and perform local training on the local model using locally available training data. The UE may provide update information regarding the locally trained model to one or more other devices (such as a network entity or a server) where the updates from other-like devices (such as other UEs) may be aggregated and used to provide an update to global or shared model. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations described herein, a first device may perform predictions via the ANN 200 based on information from a second device. For example, the first device may be a UE and the second device may be a network entity. The UE may receive a set of consistency constraints from a network entity, such as based on a capability of the UE, a recommendation from the UE, or both. The UE may obtain inference data based on the set of consistency constraints and monitor the ANN 200 (e.g., to identify data drift) in accordance with the inference data and training data satisfying the set of consistency constraints. Alternatively, the first device may be the network entity and the second device may be the UE. The network entity may output the set of consistency constraints to the UE and, in response, receive inference data which satisfies the consistency constraints. The network entity may monitor the ANN 200 in accordance with the inference data from the UE and training data satisfying the set of consistency constraints.

In some implementations, one or more devices or services may support processes relating to a ML model's usage, maintenance, activation, reporting, or the like. In certain instances, all or part of a dataset or model may be shared across multiple devices, to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions or improve performance relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a UE, a network entity such as a base station, or a disaggregated network entity such as a central unit (CU), a distributed unit (DU), a radio unit (RU), or the like.

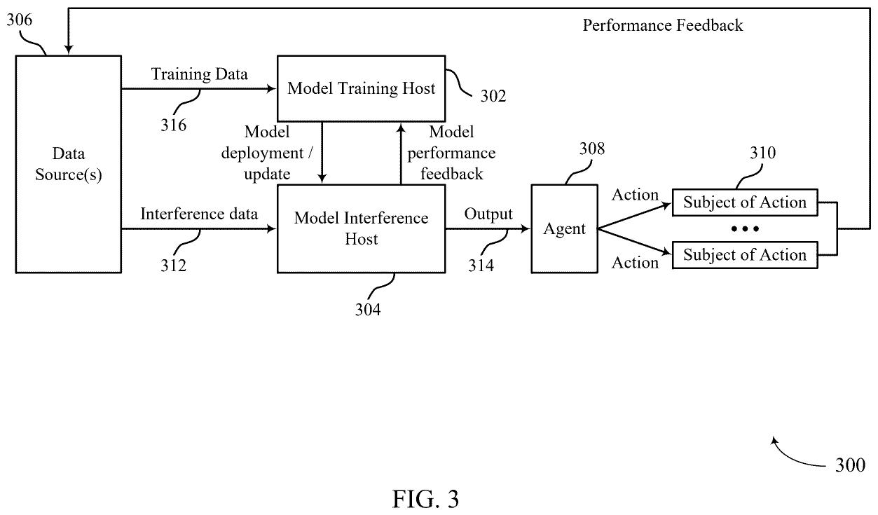

FIG. 3 shows an illustrative block diagram of an example ML architecture 300 that may be used for wireless communications in any of the various implementations, processes, environments, networks, or use cases listed above. As illustrated, the ML architecture 300 includes multiple logical entities, such as model training host 302, model inference host 304, data source(s) 306, and agent 308. Model inference host 304 is configured to run an ML model based on inference data 312 provided by data source(s) 306. Model inference host 304 may produce output 314, which may include a prediction or inference, such as a discrete or continuous value based on inference data 312, which may then be provided as input to the agent 308.

Agent 308 may represent an element or an entity of a wireless communication system including, for example, a radio access network (RAN), a wireless local area network, a device-to-device (D2D) communications system, etc. As an example, agent 308 may be a user equipment, such as a UE 115 as described with reference to FIG. 1, a base station, such as a network entity 105 as described with reference to FIG. 1, or a disaggregated network entity (such as a centralized unit (CU), a distributed unit (DU), or a radio unit (RU), an access point, a wireless station, a RAN intelligent controller (RIC) in a cloud-based RAN, among some examples. Additionally, agent 308 also may be a type of agent that depends on the type of tasks performed by model inference host 304, the type of inference data 312 provided to model inference host 304, or the type of output 314 produced by model inference host 304.

For example, if output 314 from model inference host 304 is associated with beam management, agent 308 may be or include a UE, a DU, or an RU. As another example, if output 314 from model inference host 304 is associated with transmission or reception scheduling, agent 308 may be a CU or a DU.

Agent 308 may perform one or more actions associated with receiving output 314 from model inference host 304. For example, if agent 308 is a DU or an RU and the output from model inference host 304 is associated with beam management, agent 308 may determine whether to change or modify a transmit or receive beam based on output 314. Agent 308 may indicate the one or more actions performed to at least one subject of action 310. For example, if the agent 308 determines to change or modify a transmit or receive beam for a communication between agent 308 and the subject of action 310 (such as, a UE), agent 308 may send a beam switching indication to the subject of action 310 (such as, the UE). As another example, agent 308 may be a UE and output 314 from model inference host 304 may one or more predicted channel characteristics for one or more beams. For example, model inference host 304 may predict channel characteristics for a set of beam based on the measurements of another set of beams. Based on the predicted channel characteristics, agent 308, the UE, may send, to the BS, a request to switch to a different beam for communications. In some cases, agent 308 and the subject of action 310 are the same entity.

Data can be collected from data sources 306, and may be used as training data 316 for training an ML model, or as inference data 312 for feeding an ML model inference operation. Data sources 306 may collect data from various subject of action 310 entities (such as, the UE or the network entity), and provide the collected data to a model training host 302 for ML model training. For example, a subject of action 310, such as a UE, may receive an indication of measurement resources from agent 308, such as a network entity. The UE may perform one or more measurements via the indicated measurement resources and indicate results of the measurements, such as via a measurement report, to the network entity. In some implementations, the network entity may output the measurement resources such that the measurements performed by the UE satisfy a set of consistency constraints. For example, the network entity may allocate resources to the UE in accordance with measurements included in training data for the ML model.

In some examples, if output 314 provided to agent 308 is inaccurate (or the accuracy is below an accuracy threshold), model training host 302 may provide feedback to model inference host 304 to modify or retrain the ML model used by model inference host 304, such as via an ML model deployment update.

Model training host 302 may be deployed at the same or a different entity than that in which model inference host 3104 is deployed. For example, in order to offload model training processing, which can impact the performance of model inference host 304, model training host 302 may be deployed at a model server.

In some aspects, an ML model is deployed at or on a network entity, such as the network entity 105 as described with reference to FIG. 1. In some other aspects, an ML model is deployed at or on a UE, such as the UE 115 as described with reference to FIG. 1.

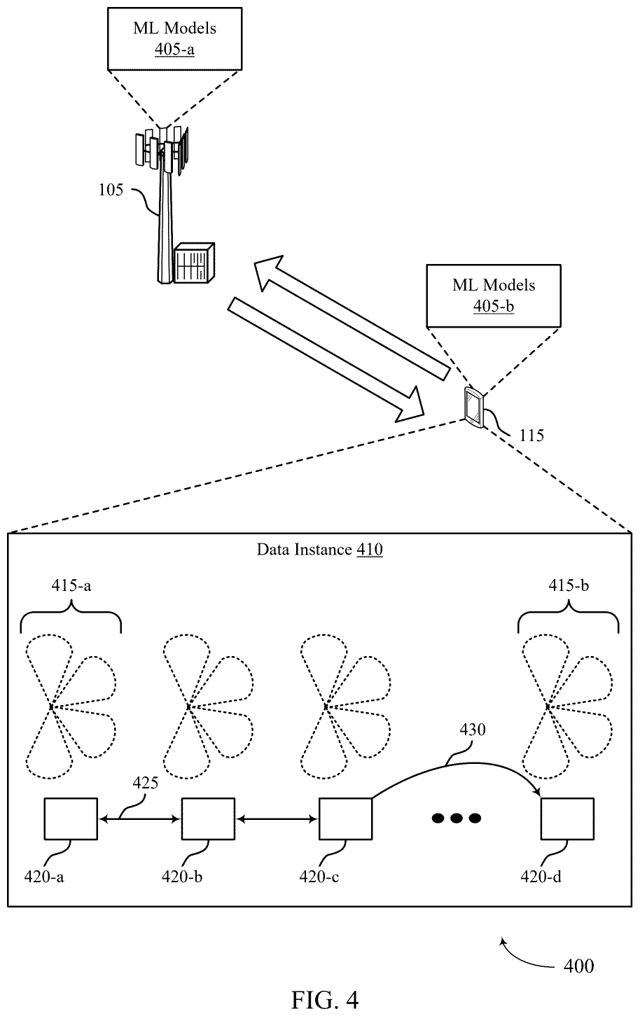

FIG. 4 shows an example of a wireless communication system 400 that supports ML model monitoring in accordance with consistency constraints in accordance with one or more aspects of the present disclosure. The wireless communication system 400 may implement or be implemented by various aspects of the wireless communications system 100, the ANN 200, the example ML architecture 300, or any combination thereof. For example, the wireless communication system 400 may include a network entity 105 and a UE 115, which may represent examples of corresponding devices as described with reference to FIG. 1. Additionally, the network entity 105 and the UE 115 may include ML models 405-a and ML models 405-b, respectively, which may implement one or more aspects of the ANN 200, the example ML architecture 300, or both.

The network entity 105 and the UE 115 may use ML models 405-a and ML models 405-b, respectively. In some aspects, the network entity 105, the UE 115, or both may perform ML model monitoring. That is, the network entity 105, the UE 115, or both may monitor ML models 405-a and ML models 405-b for data drift, concept drift, or both (e.g., after deployment of the ML models). Data drift may be associated with one or more sources. For example, a training data distribution may be referred to as Pₜᵣₐᵢₙ(X) while an inference data distribution may be referred to as P_{inference}(X). X may refer to two-dimensional data X={x₁,x₂}. The two-dimensional data may be associated with two class labels y={y₀,y₁}. In some examples, data drift, or “virtual” drift, may be in accordance with Pₜᵣₐᵢₙ(X)≠P_{inference}(X) while Pₜᵣₐᵢₙ(y|X)=P_{inference}(y|X). In such examples, the discrepancy between the training data distribution and inference data distribution may not affect a decision boundary. In another example, the data drift may be in accordance with Pₜᵣₐᵢₙ(y|X)≠P_{inference}(y|X) while Pₜᵣₐᵢₙ(X)=P_{inference}(X). In such examples, the discrepancy between the class labels in the training data distribution and the inference data distribution may affect the decision boundary. In another example, the data drift may be in accordance with Pₜᵣₐᵢₙ(y|X)≠P_{inference}(y|X) while Pₜᵣₐᵢₙ(X)≠P_{inference}(X). In such examples, the discrepancy between the class labels, training data distribution, and inference data distribution may affect the decision boundary.

In some aspects, monitoring for data drift may be referred to as concept drift detection, learning under concept drift, or the like. The network entity 105, the UE 115, or both may monitor for a mismatch (e.g., a drift) between one or more data distributions associated with the ML models and one or more environmental conditions at a given time. For example, each ML model may be associated with a data distribution, which may be an example of conditions under which the ML model is trained. The data distribution associated with training conditions for ML models may be referred to herein as a set of training information, training data instances, or the like. In some implementations, training of a ML model under one or more conditions (e.g., environmental conditions, such as indoor, outdoor, heavy traffic, sparse traffic, etc.) or configurations may affect a distribution of the ML model inputs and outputs (e.g., ground truth labels).

The data distribution associated with the ML model may represent a set of operating conditions under which the ML model may be used effectively (e.g., peak performance). In some aspects, the ML model may be associated with degraded performance when the environmental conditions deviate (e.g., beyond a threshold) from the set of operating conditions associated with the ML model. The network entity 105, the UE 115, or both may monitor the ML models to identify data drift, and, accordingly, avoid performance degradation of the ML models associated with differences between respective sets of operating conditions of the ML models and the environmental conditions at the network entity 105 or the UE 115. After identifying (e.g., detecting) data drift, the network entity 105 or the UE 115 may switch a ML model in use, fall back to a non-ML model, train a global machine-learning model (e.g., a generalized ML model associated with a broad range of operating conditions), perform on-line retraining or calibration of the ML models, or a combination thereof.

The network entity 105, the UE 115, or both may monitor respective performances of ML models 405-a and ML models 405-b according to an intermediate performance monitoring approach, an end-to-end performance monitoring approach, an input data distribution similarity approach, an input-output data distribution similarity approach, or any combination thereof. Monitoring the performance of ML models 405-a and ML models 405-b may include monitoring a distribution similarity between an input distribution and an output distribution. For example, the network entity 105 or the UE 115 may determine that a ML model is applicable to a current inference environment based on a high distribution similarity between an input distribution (e.g., training data distribution) and an output distribution (e.g., inference data distribution). Alternatively, the network entity 105 or the UE 115 may determine that a ML model is not applicable to a current inference environment based on a low distribution similarity between an input distribution (e.g., training data distribution) and an output distribution (e.g., inference data distribution).

By way of example, the network entity 105, the UE 115, or both may compare input data distributions used in training for each ML model to inference data to evaluate the performance of each ML model. In the example of beam selection, the UE 115 may compare reference signal received power (RSRP) values of a set of beams used in training to and inference RSRP values (e.g., according to ML models 405-b) of the set of beams. A distribution of the RSRP values for the training data, the inference data, or both may be in accordance with or based on an environment under which the RSRP values were measured, such as whether the RSRP values were measured indoors or outdoors. The UE 115 may compare the RSRP values used in training to RSRP values observed during an inference phase determine a performance level of each ML model of ML models 405-b with respect to current operating conditions. In other words, the UE 115 may determine which ML model includes training data which corresponds to environmental conditions most similar to current environmental conditions. In some aspects, the UE 115 may determine (e.g., calculate) a distribution similarity between the predicted beams and the measured beams based on a Kullback-Leibler divergence, a Kolmogorov-Smirnov test, an Earth mover's distance, or the like.

In some aspects, the performance of ML models 405-a or ML models 405-b may be affected by a signal-to-interference-plus-noise ratio (SINR) of an input reference signal used for training a ML model, a scheduling mode at the network entity 105 (e.g., single-user (SU)-multiple-input multiple-output (MIMO), multiple-user (MU)-MIMO, etc.), a reference signal type, a change in operating conditions (e.g., a bandwidth, a band, beam characteristics, etc.), an energy per resource element (EPRE), a quantity of ports, a quantity of panels, a quantity of antenna elements, environmental variation (e.g., rural, urban, high-Doppler, low-Doppler, high interference, low interference, etc.), or any combination thereof.

The network entity 105, the UE 115, or both may have multiple ML models to account for different environmental and operating conditions. For example, ML models 405-a, ML models 405-b, or both may include multiple ML models trained under varying environmental conditions. However, monitoring the performance of multiple ML models may be associated with a high complexity level at the network entity 105 or the UE 115, as the network entity 105 or the UE 115 may compare outputs of the model by running each model. By comparing a similarity of data distributions (e.g., rather than an output), the network entity 105, the UE 115, or both may reduce a level of complexity.

In some examples, the network entity 105, the UE 115, or both may monitor ML models 405-a and ML models 405-b, respectively, via distribution-based monitoring. Distribution-based monitoring may refer to input-based or output-based monitoring. For example, the network entity 105 and the UE 115 may compare a distribution of a set of training data to a distribution of a set of inference data. By performing distribution-based monitoring, the network entity 105 or the UE 115 may identify sources of performance degradation. As an example, the network entity 105 or the UE 115 may identify that a first beam label is under-represented in the dataset relative to one or more other beam labels. In examples in which the network entity 105 or the UE 115 is in an area of the first beam label, the network entity 105 or the UE 115 may introduce data to ML models 405-a or ML models 405-b having the first beam label.

In some cases, ML model monitoring based on a multi-dimensional distribution may not account for consistency of inputs and outputs (e.g., ground truth labels) of ML models. By way of example, the UE 115 may use ML models 405-b to select a beam of a set of beams. For example, the UE 115 may monitor ML models 405-b, select a ML model of the ML models 405-b, and select the beam of a set of beams based on the selected ML model. As an input to ML models 405-b in the example of beam prediction, the UE 115 may reassure RSRPs on multiple slots over multiple beams. For example, in a data instance 410, the UE 115 may perform measurements on a set of beams 415-a at a first occasion 420-a, a second occasion 420-b, and a third occasion 420-c, where the occasions are separated by a time duration 425. The UE 115 may perform a prediction on a set of beams 415-b at a fourth occasion 420-d, where the fourth occasion 420-d is separated from the third occasion 420-c by a time duration 430. A quantity of beams in the set of beams 415-a or the set of beams 415-b, a quantity of measurement occasions (e.g., a quantity of the occasions 420), a separation between the measurement occasions (e.g., in time, frequency, space, etc.), a duration between a last measurement occasion and a prediction occasion, or any combination thereof may be examples of data features associated with data instances. To improve an accuracy of data drift monitoring, the network entity 105, the UE 115, or both may use data instances in training data, inference data, or both which have consistent data features.

For example, when using training data and inference data for ML model monitoring having different data features, the network entity 105 and the UE 115 may inaccurately identify data drift. By way of example, the network entity 105 and the UE 115 may inaccurately identify data drift when monitoring a ML model using an inference distribution including RSRP values collected at 20 ms intervals and a training distribution including RSRP values collected at 100 ms intervals. For example, the RSRP values collected at the 100 ms intervals may be associated with a higher level of statistical variation compared to the RSRP values collected at 20 ms intervals. Alternatively, the network entity 105 and the UE 115 may improve an accuracy associated with identifying data drift when monitoring a ML model using inference distributions and training distributions including RSRP values collected at 100 ms intervals (e.g., or intervals within a threshold or range or the 100 ms intervals). In other words, if a high dissimilarity between training and inference data distributions is observed, the network entity 105 and the UE 115 may identify that data drift has occurred.

As described herein, the network entity 105 and the UE 115 may perform ML model monitoring according to consistency constraints. For example, the network entity 105 may configure the UE 115 with consistency constraints on inference and training data distributions used for statistical ML model monitoring. In examples described herein, data distributions, including training data distributions and inference data distributions, may include different measurements (e.g., interference, SINR, RSRP, CSI, channel quality indication (CQI), etc.) for different use cases. The consistency constraints may include one or more of a distribution dimension consistency, a resource separation consistency, a measurement resource consistency, or an EPRE consistency. As used herein, “consistency” may refer to being within a range of a data feature. That is, the consistency constraints may include one or more of the distribution dimension consistency, the resource separation consistency, the measurement resource consistency, or the EPRE consistency, where the network entity 105 or the UE 115 may include measurement instances having data features within a range of the consistency constraints. In some examples, the network entity 105 may indicate the range to the UE 115, or the range may be predefined.

For example, the distribution dimension consistency may refer to a quantity of measurements per data instance. As an example, the network entity 105 may configure each data instance in the training and inference data distributions to include 3 dimensions: SINR(t), SINR(t+100 ms), and SINR(t+200 ms). When monitoring a ML model of ML models 405-b, the UE 115 may include in the training and inference data distributions SINR measurements meeting the distribution dimension consistency. In some examples, training data may be collected under inconsistent sub-sampling and different slot separations to allow more flexibility in prediction. For example, a training data instance may include SINR(t), SINR(t+50 ms), SINR(t+100 ms), SINR(t+150 ms), and SINR(t+200 ms). The UE 115 may use the values of SINR(t), SINR(t+100 ms), and SINR(t+200 ms) as a 3 dimensional data instance in the training data distribution used for monitoring the ML model. That is, values of SINR(t+50 ms) and SINR(t+150 ms) will not be included in monitoring such that the distribution dimension consistency is satisfied. The distribution dimension may not be related to a quantity of measurements used as inputs and outputs to the ML model. That is, the UE 115 may use varying quantities of measurements in SINR(t), SINR(t+100 ms), and SINR(t+200 ms). After training and inference SINR distributions are constructed in accordance with the distribution dimension consistency, the UE 115 may compare the similarity of the training and inference data distributions. For example, the UE 115 may determine whether the ML model is suitable for a current interference environment at the UE 115.

A resource separation consistency may refer to a separation in time, frequency, or space between measurements. In the example of FIG. 4, the separation in time may refer to the time duration 425 separating each occasion 420. The network entity 105 may configure the separation in time (e.g., in slots, ms, etc.), in frequency (e.g., in sub-bands, resource blocks, etc.), and in space (e.g., in beams) between different measurements included in the training data distribution and the inference data distribution. As an example, the network entity 105 may configure the UE 115 to monitor SINR drift by monitoring a joint distribution of SINR at a time t and at a time t+100 ms on same beam(s) and same sub-band(s). The network entity 105 may configure measurement resources (e.g., CSI-RS resources) to satisfy the configured time separation during the ML model monitoring occasions. In other words, the network entity 105 may output an indication of measurement resources for the UE 115 which satisfy the resource separation consistency. The UE 115 may generate the inference data distribution according to the resource separation consistency (e.g., and one or more other consistency constraints). Additionally, or alternatively, the UE 115 may include instances of training data which satisfy the resource separation consistency in the training data distribution. After generating the inference data distribution and selecting training data to include in the training data distribution, the UE 115 may monitor the ML model by comparing a similarity between the training and inference data distributions.

The measurement resource consistency may refer to a type of reference signal used as a measurement resource. For example, the measurement resource consistency may indicate that measurements of a first reference signal type (e.g., CSI-RS, synchronization signal block (SSB), demodulation reference signal (DMRS), etc.) may be included in training data distributions, inference data distributions, or both. Additionally, or alternatively, the measurement resource consistency may be associated with a beam codebook consistency. For example, different network entities may have different beam codebooks (e.g., used to generate SSBs or CSI-RSs). The network entity 105 may configure the UE 115 to ensure that beam codebooks are consistent across training and inference data distributions. As an example, the UE 115 may be configured to construct inference and training data distributions including SINRs at a time t and at a time t+100 ms. The network entity 105 may configure the UE 115 to include measurements in the inference and training data distributions where CSI-RS is used at a measurement resource at both the time t and at the time t+100 ms. That is, the UE 115 may refrain from including measurements in the inference or training data distributions if SSB is used as a measurement resource.

The EPRE consistency may refer to an EPRE ratio between reference signals used as measurement resources. For example, the network entity 105 may configure the EPRE ratio(s) between reference signals (e.g., CSI-RSs) used as measurement resources to be the same between corresponding data samples. As an example, the UE 115 may be configured to construct inference and training data distributions including SINRs at the time t and at the time t+100 ms when the EPRE ratio between reference signals at the time t and at the time t+100 ms is x dB. That is, the UE 115 may refrain from including measurements in the inference or training data distributions if the EPRE ratio between reference signals at the time t and at the time t+100 ms is not x dB or is not within a range of x dB.

The network entity 105 and the UE 115 may exchange an indication of the consistency constraints. For example, the network entity 105 may output one or more messages indicative of the consistency constraints. In some examples, the one or more messages may include a row in a table. For example, the network entity 105 may indicate a row index of a table, where the row includes the consistency constraints. That is, the UE 115 may identify the consistency constraints by looking up the row index in the table. Additionally, or alternatively, the UE 115 may identify the consistency constraints (e.g., implicitly or explicitly) based on a resource configuration. For example, the UE 115 may obtain a resource configuration associated with a quantity of measurements per data instance, a separation between measurements of data instances, a reference signal type, an EPRE ratio, or any combination thereof. The UE 115 may identify data features associated with the resource configuration as being the consistency constraints. As an example, the network entity 105 may configure the UE 115 with periodic or semi-periodic CSI-RS resources with a periodicity of p slots during a ML model monitoring period. The UE 115 may use the CSI-RS resources to generate a SINR data distribution with a measurement separation of p slots. The UE 115 may not include one or more SINR measurements in the inference or training data distributions which do not have data features corresponding to the periodic or semi-periodic CSI-RS resources, such as measurements not having the measurement separation of p slots or measurements obtained via a different type of reference signal.

In some examples, the resource configuration (e.g., a CSI-RS resource setting) may include a field (e.g., ‘isFollowConsistencyRequirement’) that indicates that the resource configuration is indicative of the consistency constraints. For example, the field may include a first value (e.g., True) to indicate that the UE 115 is to collect data distributions following the configuration in the configured reference signal. Or the field may include a second value (e.g., False) to indicate that the UE 115 does not necessarily collect the data distribution following the configuration in the configured reference signal. That is, the UE 115 may generate an inference data distribution or select data for a training data distribution in accordance with data features of the resource configuration based on the field in the resource configuration.

The network entity 105 or the UE 115 may associate consistency constraints with a functionality of the ML model or an identifier of the ML model. That is, consistency constraints may correspond to different ML models of ML models 405-a or ML models 405-b according to a functionality or identifier. For example, a predefined table may map the consistency constraints based on the functionality or the identifier. Additionally, or alternatively, the network entity 105 may configure the UE 115 to associate the consistency constraints with the functionality or identifier. For example, if the ML model functionality supports spatial beam prediction, the network entity 105 or the UE 115 may construct training or inference RSRP data distributions such that each data instance contains N beams α° apart in an Azimuth or elevation direction for statistical ML model monitoring. As another example, it the ML model functionality supports SINR prediction for 100 ms in future, the network entity 105 or the UE 115 may construct a 2-dimensional training or inference SINR data distribution where each data instance includes SINR(t) and SINR(t+100 ms).

In some examples, the UE 115 may associate consistency constraints with a configuration of ML model functionality. For example, a single ML model may support multiple ML model functionalities. In such examples, the consistency constraints may be defined based on a functionality configured by the network entity 105. As an example, the network entity 105 may configure the UE 115 to perform SINR predictions 100 ms in the future. According to the configuration from the network entity 105, the UE 115 may construct a 2-dimensional SINR distribution (e.g., having SINR(t) and SINR(t+100 ms)) during inference and compare the similarity of the 2-dimensional SINR distribution similarity with a training data distribution constructed according to the consistency constraints to detect data drifts. As another example, the network entity 105 may configure the UE 115 to perform SINR predictions 200 ms in the future. According to the configuration from the network entity 105, the UE 115 may construct a 2-dimensional SINR distribution (e.g., having SINR(t) and SINR(t+200 ms)) during inference and compare the similarity of the 2-dimensional SINR distribution similarity with a training data distribution constructed according to the consistency constraints to detect data drifts.

The network entity 105, the UE 115, or both may perform ML model finetuning, switching, or fallback according to dissimilarity of consistency-compliant distributions. In the example of a UE-side ML model, the UE 115 may compare an inference data distribution with a training data distribution to finetune or switch the ML model, activate or deactivate parts of the ML model, continue using the ML model, or fall back to another operation (e.g., not using a ML model). For example, the UE 115 may perform one or more operations associated with the ML model according to dissimilarity thresholds associated with inference and training data distributions.

The UE 115 may report a capability associated with the consistency constraints. For example, the UE 115 may report a threshold distribution dimension supported for comparing a similarity between training and inference data distributions. As another example, the UE 115 may report a threshold resource separation supported for constructing an inference data distribution. In some examples, the UE 115 may report the capability via a RRC message.

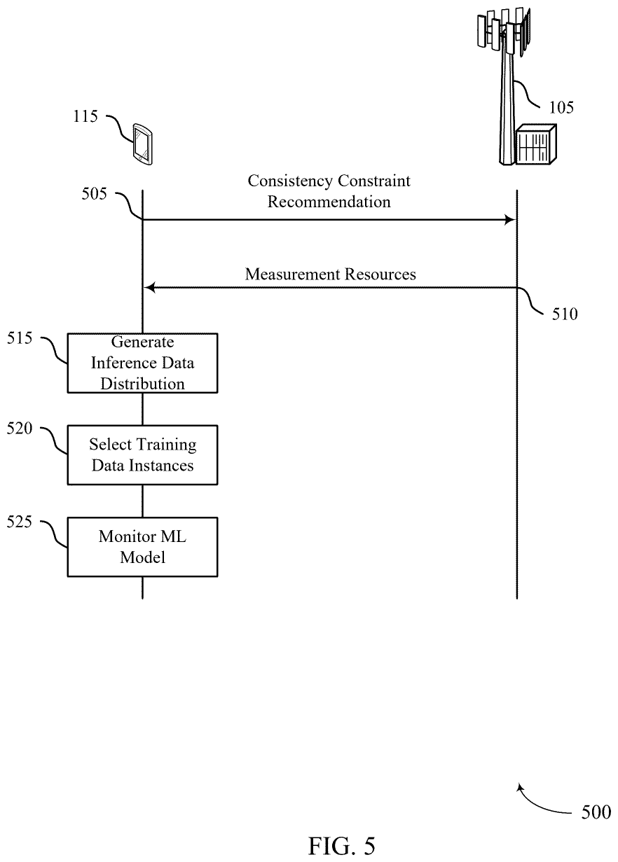

FIG. 5 shows an example of a process flow 500 that supports ML model monitoring in accordance with consistency constraints in accordance with one or more aspects of the present disclosure. In some aspects, the process flow 500 may implement or be implemented by aspects of the wireless communications system 100, the ANN 200, the example ML architecture 300, or the wireless communication system 400 as described with reference to FIGS. 1-4. For example, the process flow 500 may include a UE 115 and a network entity 105, which may be examples of corresponding devices as described with reference to FIGS. 1 and 4.

Alternative examples of the following may be implemented, where some steps are performed in a different order than described or are not performed at all. In some cases, steps may include additional features not mentioned below, or further steps may be added. Although the UE 115 and the network entity 105 are shown performing the operations of the process flow 500, some aspects of some operations may also be performed by one or more other wireless devices.

In the example of FIG. 5, the UE 115 may include a ML model. In other words, training data associated with the ML model may be available at the UE 115. The UE 115 may perform ML model monitoring according to consistency constraints, where inference data generated by the UE 115 and training data used for the ML model satisfy the consistency constraints.

At 505, the UE 115 may transmit a consistency constraint recommendation. For example, the UE 115 may share a recommendation regarding the consistency constraints for measurements used in constructing training data distributions, inference data distributions, or both used in ML model monitoring. The recommendation associated with the consistency constraints may include a distribution dimension, resource separation, measurement resource, and EPRE consistency. In some examples, the recommendation may be based on the training data, such as the training data distribution available at the UE 115. For example, the UE 115 may recommend that the consistency constraints be similar to the training data. In other words, the UE 115 may recommend the distribution dimension, resource separation, measurement resource, and EPRE consistency according to the training data. The UE 115 may transmit the recommendation via a RRC message, a MAC-control element (CE) message, or an uplink control information (UCI) message.

At 510, the network entity 105 may output an indication of measurement resources. For example, the network entity 105 may configure the UE 115 with one or more measurement resources, where the measurement resources are in accordance with or satisfy the consistency constraint recommendation. That is, following the recommendation from the UE 115, the network entity 105 may configure the UE 115 with reference signals (e.g., CSI-RS) to satisfy the consistency constraints. As an example, the UE 115 may recommend constructing the inference distribution with SINR measurements separated by 100 ms, and the network entity 105 may configure the UE 115 with periodic or semi-persistent CSI-RS resources separated by 100 ms.

At 515, the UE 115 may generate the inference data distribution. For example, the UE 115 may construct the inference data distribution in accordance with the consistency constraints. In some examples, the measurement resources may indicate (e.g., implicitly or explicitly) the consistency constraints. For example, the UE 115 may construct the inference data according to the measurement resources or, in some examples, a field in the measurement resources. Alternatively, the network entity 105 may output signaling (e.g., separate from the signaling indicating the measurement resources) indicating the consistency constraints. The consistency constraints indicated by the network entity 105 may be in accordance with the recommendation from the UE 115, or the network entity 105 may determine consistency constraints different than the recommendation from the UE 115. In some examples, the network entity 105 may indicate the consistency constraints in accordance with the ML model being at the UE 115. For example, the network entity 105 may configure reference signals (e.g., CSI-RS) for the UE to measure (e.g., measure SINR), where the configured reference signals satisfy the consistency constraints.

At 520, the UE 115 may select training data instances. For example, the UE 115 may select training data instances satisfying the consistency constraints. That is, the UE 115 may select training data instances according to the measurement resources indicating the consistency constraints or the signaling indicating the consistency constraints. At 525, the UE 115 may monitor the ML model. For example, after generating the inference data distribution and selecting the training data instances, the UE 115 may monitor the ML model. In other words, the UE 115 may monitor the ML model in accordance with the inference data distribution and the selected training data instances satisfying the consistency constraints.

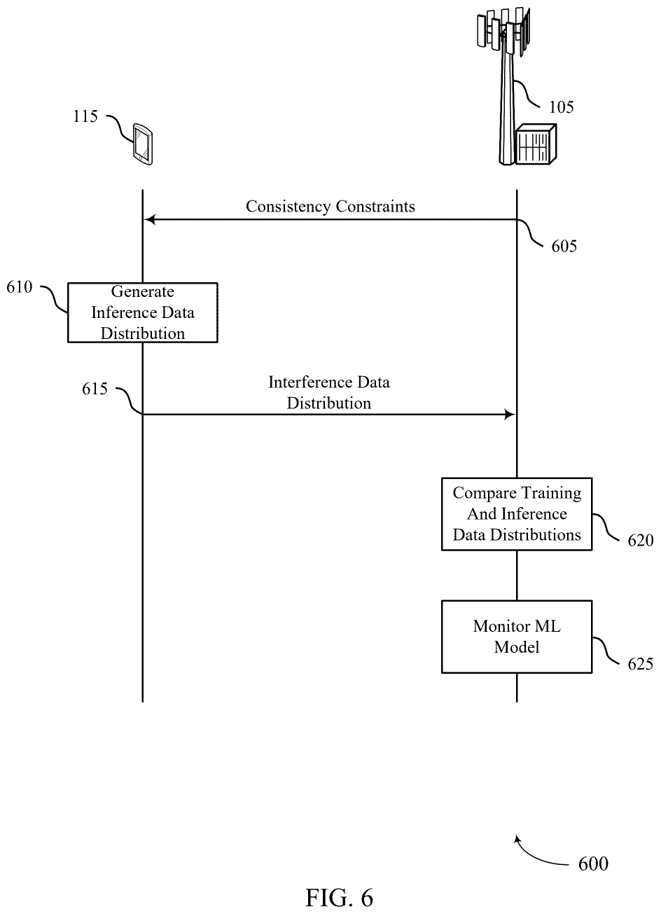

FIG. 6 shows an example of a process flow 600 that supports ML model monitoring in accordance with consistency constraints in accordance with one or more aspects of the present disclosure. In some aspects, the process flow 600 may implement or be implemented by aspects of the wireless communications system 100, the ANN 200, the example ML architecture 300, or the wireless communication system 400 as described with reference to FIGS. 1-4. For example, the process flow 600 may include a UE 115 and a network entity 105, which may be examples of corresponding devices as described with reference to FIGS. 1 and 4.

Alternative examples of the following may be implemented, where some steps are performed in a different order than described or are not performed at all. In some cases, steps may include additional features not mentioned below, or further steps may be added. Although the UE 115 and the network entity 105 are shown performing the operations of the process flow 600, some aspects of some operations may also be performed by one or more other wireless devices.

In the example of FIG. 6, the network entity 105 may include a ML model. In other words, training data associated with the ML model may be available at the network entity 105. The UE 115 may perform ML model monitoring according to consistency constraints, where inference data and training data used for the ML model satisfy the consistency constraints.

At 605, the network entity 105 may indicate consistency constraints. The consistency constraints may include a distribution dimension, resource separation, measurement resource, and EPRE consistency. In some examples, the network entity 105 may determine the consistency constraints according to the training data, such as the training data distribution available at the network entity 105. In other words, the network entity 105 may determine the distribution dimension, resource separation, measurement resource, and EPRE consistency according to the training data. In some examples, the network entity 105 may indicate the consistency constraints in accordance with the ML model being at the network entity 105. For example, the ML model and training data may be available at the network entity 105, while the UE 115 may be a node collecting inference data. The network entity 105 may indicate the consistency constraints via a RRC message, a MAC-CE message, or a DCI message.

At 610, the UE 115 may generate the inference data distribution. For example, the UE 115 may construct the inference data distribution in accordance with the consistency constraints. After generating the inference data distribution, at 615, the UE 115 may report the inference data distribution to the network entity 105. For example, the UE 115 may report the inference data distribution for ML model monitoring at the network entity 105.

At 620, the network entity 105 may compare training and inference data distributions. For example, the network entity 105 may determine a similarity between the training data distribution of the ML model and the inference data distribution generated by the UE 115. The network entity 105 may determine the similarity in accordance with the training data distribution and the inference data distribution satisfying the consistency constraints. After comparing the training and inference data distributions, at 625, the network entity 105 may monitor the ML model. For example, the network entity 105 may compare the training and inference data distributions at 620 for the ML model monitoring at 625.

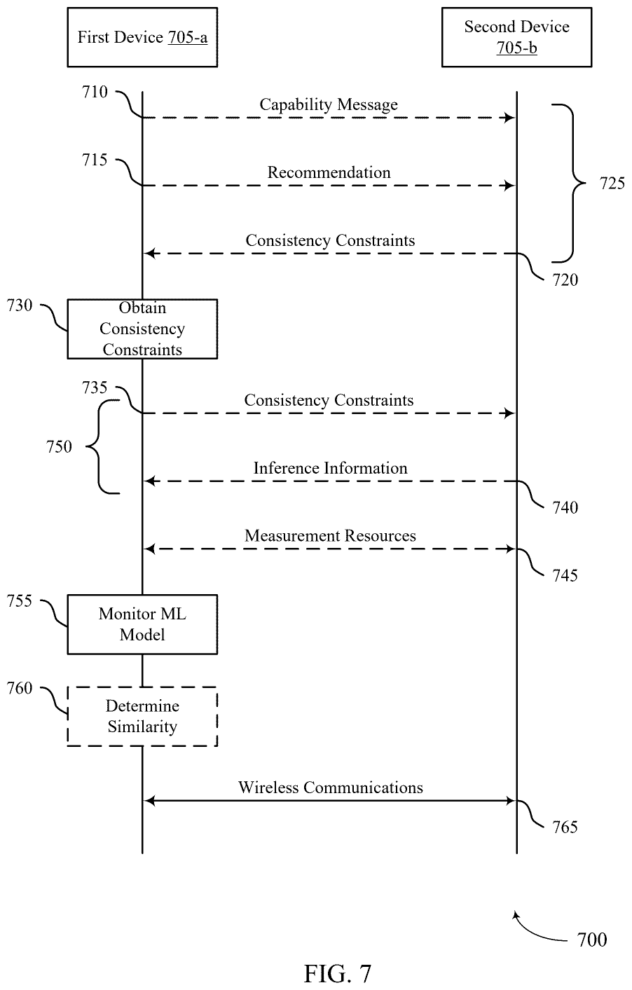

FIG. 7 shows an example of a process flow 700 that supports ML model monitoring in accordance with consistency constraints in accordance with one or more aspects of the present disclosure. In some aspects, the process flow 700 may implement or be implemented by aspects of the wireless communications system 100, the ANN 200, the example ML architecture 300, or the wireless communication system 400 as described with reference to FIGS. 1-4. For example, the process flow 700 may include a first device 705-a and a second device 705-b, which may be examples of corresponding devices, such as a network entity 105 and a UE 115, as described with reference to FIGS. 1 and 4.

Alternative examples of the following may be implemented, where some steps are performed in a different order than described or are not performed at all. In some cases, steps may include additional features not mentioned below, or further steps may be added. Although the first device 705-a and the second device 705-b are shown performing the operations of the process flow 500, some aspects of some operations may also be performed by one or more other wireless devices.

At 710, the first device 705-a may transmit a capability message to the second device 705-b. For example, the first device 705-a may output a capability message indicating a capability of the first device 705-a to support one or more consistency constraints. The first device 705-a may obtain a set of consistency constraints at 730, or receive an indication of the set of consistency constraints at 720, in accordance with the capability of the first device 705-a.

At 715, the first device 705-a may transmit a recommendation to the second device 705-b. For example, the first device 705-a may output a recommendation associated with the set of consistency constraints, where the recommendation is in accordance with a set of training information of a ML model. In such examples, the ML model and the associated training information may be at the first device 705-a. The recommendation may be an example of the consistency constraint recommendation at 505 as described with reference to FIG. 5.

At 720, the second device 705-b may transmit an indication of consistency constraints to the first device 705-a. For example, the first device 705-a may receive one or more messages indicative of the set of consistency constraints. In some examples, the first device 705-a may receive the indication of the set of consistency constraints in accordance with the capability, the recommendation, or both. For example, the second device 705-b may determine the consistency constraints in accordance with the capability, the recommendation, or both and indicate the consistency constraints to the first device 705-a.

In some examples, the ML model may be at a UE. For example, a first set of operations 725, including the capability message, recommendation, and indication of the consistency constraints may be implemented in examples in which the first device 705-a is a UE. The first set of operations 725 may be examples of one or more operations described with reference to FIG. 5. In alternative examples in which the ML model is at a network entity, it may be understood that the network entity may obtain the capability message and recommendation and output the consistency constraints.

At 730, the first device 705-a may obtain consistency constraints. For example, the first device 705-a may obtain a set of consistency constraints associated with monitoring a ML model, the ML model associated with a set of training information including first data instances. The set of consistency constraints may be associated with the first data instances within the set of training information and second data instances within a set of inference information being in accordance with consistent parameter values. In other words, the set of consistency constraints may be satisfied when the first data instances and second data instances have the consistent parameter values. As described herein, “consistent” may refer to a parameter being within a range of a corresponding parameter. For example, a first parameter of the set of training information may correspond to a second parameter of the set of inference information, where the first parameter and the second parameter are within the range of each other.

The set of consistency constraints may include a distribution dimension consistency constraint associated with a quantity of measurements per data instance. In such examples, the first data instances and the second data instances satisfying the distribution dimension consistency constraint may include data instances within the first data instances including a first quantity of measurements and data instances within the second data instances including the first quantity of measurements or a second quantity of measurements that is within a threshold of the first quantity of measurements. For example, the first data instances of the set of training information may have X measurements, and the second data instances of the set of inference information may have Y measurements. To satisfy the distribution dimension consistency, X may be the same as Y, or X may be within a threshold t of Y. That is, the distribution dimension consistency may be satisfied if X=Y±t or if Y=X±t.

The set of consistency constraints may include a resource separation consistency constraint associated with a separation within a domain between measurements included in respective data instances. The domain may include a time domain, a frequency domain, a beam direction domain, or any combination thereof. In such examples, the first f data instances and the second data instances satisfying the resource separation consistency constraint may include data instances within the first data instances including measurements that are separated according to a first separation within the domain and data instances within the second data instances including measurements that are separated according to the first separation or a second separation within the domain that is within a threshold of the first separation. For example, the first data instances of the set of training information may have a separation X, and the second data instances of the set of inference information may have a separation Y. To satisfy the resource separation consistency, X may be the same as Y, or X may be within a threshold t of Y. That is, the distribution dimension consistency may be satisfied if X=Y±t or if Y=X±t.

The set of consistency constraints may include a measurement resource consistency constraint associated with a type of reference signal used for measurements included in respective data instances. In such examples, the first data instances and the second data instances satisfying the measurement resource consistency constraint may include a same type of reference signal being used for measurements included in data instances within the first data instances and for measurements included in data instances within the second data instances. For example, measurements of the inference data and training data may be taken from the same type of reference signal according to the measurement resource consistency constraint.

The set of consistency constraints may include an EPRE consistency constraint associated with an EPRE ratio between reference signals used for measurements included in respective data instances. In such examples, the first data instances and the second data instances satisfying the EPRE consistency constraint may include first reference signals for measurements included in data instances within the first data instances and second reference signals for measurements included in data instances within the second data instances being in accordance with the EPRE ratio. In some examples, the first reference signals and second reference signals being in accordance with the EPRE ratio may include being the same as an indicated EPRE ratio or within a range of the indicated EPRE ratio.

In some examples, the first device 705-a may obtain the consistency constraints according to a resource configuration. For example, the first device 705-a may obtain a resource configuration associated with a quantity of measurements per data instance, a separation between measurements of data instances, a reference signal type, an EPRE ratio, or any combination thereof. In some examples, the resource configuration may include a field that indicates that the resource configuration is indicative of the set of consistency constraints. The first device 705-a may identify (e.g., obtain) the set of consistency constraints in accordance with the resource configuration.

In some other examples, the first device 705-a may obtain the consistency constraints according to a functionality or an identifier. For example, the ML model may be associated with one or more functionalities, an identifier, or both. The first device 705-a may obtain the set of consistency constraints in accordance with an association between the set of consistency constraints and a functionality of the one or more functionalities, the identifier, or both.

At 735, the first device 705-a may transmit an indication of the consistency constraints to the second device 705-b. For example, the first device 705-a may output one or more messages indicative of the set of consistency constraints. At 740, in response to the consistency constraints at 735, the second device 705-b may transmit an indication of inference information to the first device 705-a. For example, the first device 705-a may obtain, in response to the one or more messages indicative of the set of consistency constraints, the set of inference information, where monitoring the ML model is in accordance with the set of inference information.

In some examples, the ML model may be at a network entity. For example, a second set of operations 750, including the consistency constraints and the inference information, may be implemented in examples in which the first device 705-a is a network entity. That is, the network entity may determine the consistency constraints in accordance with the set of training information at the network entity, indicate the consistency constraints to a UE, and receive a report indicative of the inference information satisfying the consistency constraints. In other words, the UE may obtain the set of inference information (e.g., regardless of the ML model being at the network entity). The second set of operations 750 may be examples of one or more operations described with reference to FIG. 6.

At 745, the second device 705-b may transmit an indication of measurement resources to the first device 705-a. For example, the first device 705-a and the second device 705-b may communicate one or more messages indicative of a set of measurement resources to be used by the first device 705-a for measurements associated with the second data instances, where the set of measurement resources are in accordance with the set of consistency constraints. For example, the first device 705-a may obtain one or more messages indicative of a set of measurement resources to be used by the first device 705-a for measurements included in the second data instances, where the set of measurement resources are in accordance with the resource separation consistency constraint. That is, in examples in which the set of consistency constraints includes the resource separation consistency constraint, measurement resources may align with the resource separation consistency constraint.

At 755, the first device 705-a may monitor the ML model. For example, the first device 705-a may monitor the ML model in response to the first data instances and the second data instances satisfying the set of consistency constraints. In some examples, the first device 705-a may monitor the ML model using a subset of the first data instances associated with the set of training information, where the subset of the first data instances and the second data instances satisfy the set of consistency constraints. In other words, the first device 705-a may use the training information which satisfies the set of consistency constraints and may exclude one or more data instances. The first device 705-a may select data instances of the set of training information in accordance with the set of consistency constraints. The first device 705-a may use the selected data instances for monitoring the ML model at 755.

At 760, the first device 705-a may determine a similarity. For example, the first device 705-a may determine a similarity between the set of training information and the set of inference information. Monitoring the ML model at 755 may involve or include determining the similarity at 760.

At 765, the first device 705-a and the second device 705-b may perform wireless communications. For example, the first device 705-a may perform the wireless communications in accordance with monitoring the ML model. That is, the first device 705-a may perform one or more operations in accordance with detecting data drift or failing to detect data drift during ML model monitoring. The data drift may be detected with a relatively high level of accuracy in accordance with application of the set of consistency constraints.

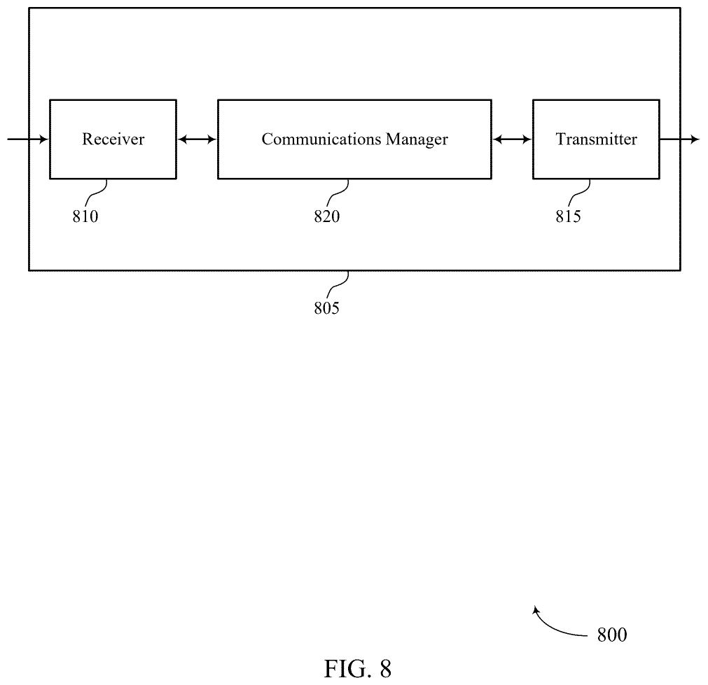

FIG. 8 shows a block diagram 800 of a device 805 that supports ML model monitoring in accordance with consistency constraints in accordance with one or more aspects of the present disclosure. The device 805 may be an example of aspects of a network entity 105 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

Additionally, or alternatively, the receiver 810 may provide a means for receiving information such as packets, user data, control information, or any combination thereof associated with various information channels (e.g., control channels, data channels, information channels related to ML model monitoring in accordance with consistency constraints). Information may be passed on to other components of the device 805. The receiver 810 may utilize a single antenna or a set of multiple antennas.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

Additionally, or alternatively, the transmitter 815 may provide a means for transmitting signals generated by other components of the device 805. For example, the transmitter 815 may transmit information such as packets, user data, control information, or any combination thereof associated with various information channels (e.g., control channels, data channels, information channels related to ML model monitoring in accordance with consistency constraints). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of ML model monitoring in accordance with consistency constraints as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for obtaining a set of consistency constraints associated with monitoring a ML model, the ML model associated with a set of training information including a first set of multiple data instances, where the set of consistency constraints are associated with the first set of multiple data instances within the set of training information and a second set of multiple data instances within a set of inference information being in accordance with consistent parameter values. The communications manager 820 is capable of, configured to, or operable to support a means for monitoring the ML model in response to the first set of multiple data instances and the second set of multiple data instances satisfying the set of consistency constraints. The communications manager 820 is capable of, configured to, or operable to support a means for performing the wireless communications in accordance with monitoring the ML model.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, and more efficient utilization of communication resources.

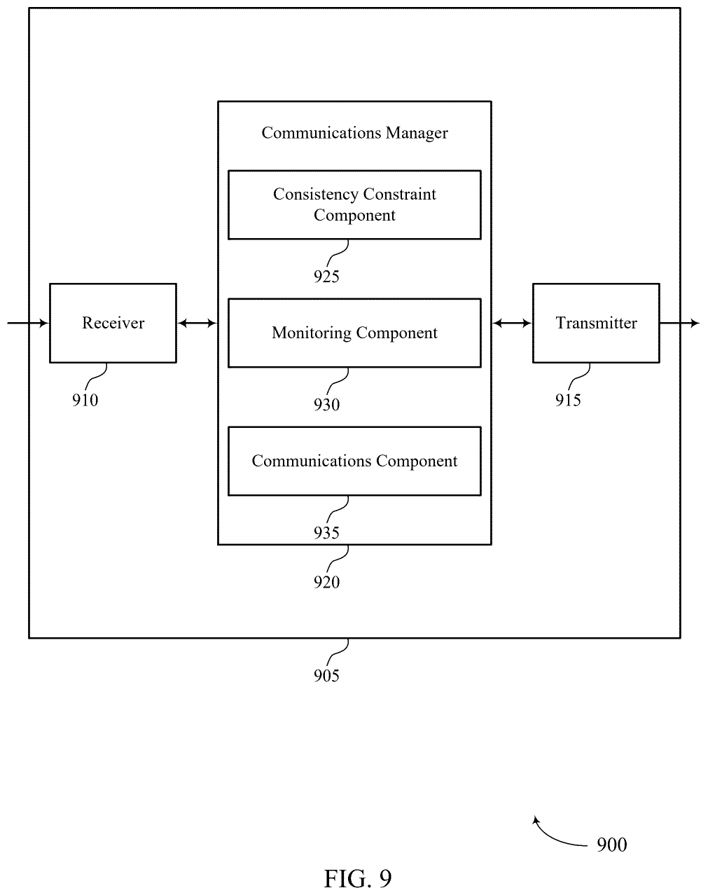

FIG. 9 shows a block diagram 900 of a device 905 that supports ML model monitoring in accordance with consistency constraints in accordance with one or more aspects of the present disclosure. The device 905 may be an example of aspects of a device 805, a network entity 105, or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

Additionally, or alternatively, the receiver 910 may provide a means for receiving information such as packets, user data, control information, or any combination thereof associated with various information channels (e.g., control channels, data channels, information channels related to ML model monitoring in accordance with consistency constraints). Information may be passed on to other components of the device 905. The receiver 910 may utilize a single antenna or a set of multiple antennas.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

Additionally, or alternatively the transmitter 915 may provide a means for transmitting signals generated by other components of the device 905. For example, the transmitter 915 may transmit information such as packets, user data, control information, or any combination thereof associated with various information channels (e.g., control channels, data channels, information channels related to ML model monitoring in accordance with consistency constraints). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of ML model monitoring in accordance with consistency constraints as described herein. For example, the communications manager 920 may include a consistency constraint component 925, a monitoring component 930, a communications component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The consistency constraint component 925 is capable of, configured to, or operable to support a means for obtaining a set of consistency constraints associated with monitoring a ML model, the ML model associated with a set of training information including a first set of multiple data instances, where the set of consistency constraints are associated with the first set of multiple data instances within the set of training information and a second set of multiple data instances within a set of inference information being in accordance with consistent parameter values. The monitoring component 930 is capable of, configured to, or operable to support a means for monitoring the ML model in response to the first set of multiple data instances and the second set of multiple data instances satisfying the set of consistency constraints. The communications component 935 is capable of, configured to, or operable to support a means for performing the wireless communications in accordance with monitoring the ML model.

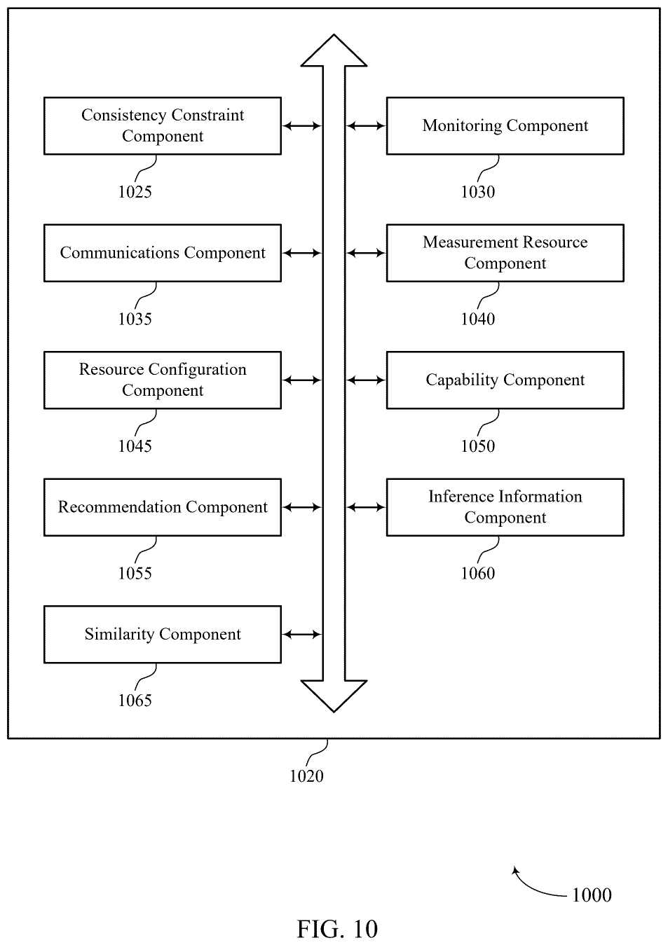

FIG. 10 shows a block diagram 1000 of a communications manager 1020 that supports ML model monitoring in accordance with consistency constraints in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of ML model monitoring in accordance with consistency constraints as described herein. For example, the communications manager 1020 may include a consistency constraint component 1025, a monitoring component 1030, a communications component 1035, a measurement resource component 1040, a resource configuration component 1045, a capability component 1050, a recommendation component 1055, an inference information component 1060, a similarity component 1065, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The consistency constraint component 1025 is capable of, configured to, or operable to support a means for obtaining a set of consistency constraints associated with monitoring a ML model, the ML model associated with a set of training information including a first set of multiple data instances, where the set of consistency constraints are associated with the first set of multiple data instances within the set of training information and a second set of multiple data instances within a set of inference information being in accordance with consistent parameter values. The monitoring component 1030 is capable of, configured to, or operable to support a means for monitoring the ML model in response to the first set of multiple data instances and the second set of multiple data instances satisfying the set of consistency constraints. The communications component 1035 is capable of, configured to, or operable to support a means for performing the wireless communications in accordance with monitoring the ML model.

In some examples, the set of consistency constraints includes a distribution dimension consistency constraint associated with a quantity of measurements per data instance, where the first set of multiple data instances and the second set of multiple data instances satisfying the distribution dimension consistency constraint includes data instances within the first set of multiple data instances including a first quantity of measurements, and data instances within the second set of multiple data instances including the first quantity of measurements or a second quantity of measurements that is within a threshold of the first quantity of measurements.

In some examples, the set of consistency constraints includes a resource separation consistency constraint associated with a separation within a domain between measurements included in respective data instances, where the domain includes a time domain, a frequency domain, a beam direction domain, or any combination thereof, and where the first set of multiple data instances and the second set of multiple data instances satisfying the resource separation consistency constraint includes data instances within the first set of multiple data instances including measurements that are separated according to a first separation within the domain, and data instances within the second set of multiple data instances including measurements that are separated according to the first separation or a second separation within the domain that is within a threshold of the first separation.

In some examples, the measurement resource component 1040 is capable of, configured to, or operable to support a means for obtaining one or more messages indicative of a set of measurement resources to be used by the first device for measurements included in the second set of multiple data instances, where the set of measurement resources are in accordance with the resource separation consistency constraint.

In some examples, the set of consistency constraints includes a measurement resource consistency constraint associated with a type of reference signal used for measurements included in respective data instances, and where the first set of multiple data instances and the second set of multiple data instances satisfying the measurement resource consistency constraint includes a same type of reference signal being used for measurements included in data instances within the first set of multiple data instances and for measurements included in data instances within the second set of multiple data instances.

In some examples, the set of consistency constraints include an EPRE consistency constraint associated with an EPRE ratio between reference signals used for measurements included in respective data instances, and where the first set of multiple data instances and the second set of multiple data instances satisfying the EPRE consistency constraint includes first reference signals for measurements included in data instances within the first set of multiple data instances and second reference signals for measurements included in data instances within the second set of multiple data instances being in accordance with the EPRE ratio.

In some examples, the measurement resource component 1040 is capable of, configured to, or operable to support a means for communicating one or more messages indicative of a set of measurement resources to be used by the first device for measurements associated with the second set of multiple data instances, where the set of measurement resources are in accordance with the set of consistency constraints.

In some examples, to support obtaining the set of consistency constraints, the consistency constraint component 1025 is capable of, configured to, or operable to support a means for receiving one or more messages indicative of the set of consistency constraints.

In some examples, to support obtaining the set of consistency constraints, the resource configuration component 1045 is capable of, configured to, or operable to support a means for obtaining a resource configuration associated with a quantity of measurements per data instance, a separation between measurements of data instances, a reference signal type, an EPRE ratio, or any combination thereof. In some examples, to support obtaining the set of consistency constraints, the consistency constraint component 1025 is capable of, configured to, or operable to support a means for identifying the set of consistency constraints in accordance with the resource configuration.

In some examples, the resource configuration includes a field that indicates that the resource configuration is indicative of the set of consistency constraints.

In some examples, to support obtaining the set of consistency constraints, the consistency constraint component 1025 is capable of, configured to, or operable to support a means for obtaining the set of consistency constraints in accordance with an association between the set of consistency constraints and a functionality of the one or more functionalities, the identifier, or both.

In some examples, to support obtaining the set of consistency constraints, the capability component 1050 is capable of, configured to, or operable to support a means for outputting a capability message indicating a capability of the first device to support one or more consistency constraints. In some examples, to support obtaining the set of consistency constraints, the consistency constraint component 1025 is capable of, configured to, or operable to support a means for obtaining the set of consistency constraints in accordance with the capability of the first device.

In some examples, the recommendation component 1055 is capable of, configured to, or operable to support a means for outputting a recommendation associated with the set of consistency constraints, where the recommendation is in accordance with the set of training information.

In some examples, the consistency constraint component 1025 is capable of, configured to, or operable to support a means for outputting one or more messages indicative of the set of consistency constraints. In some examples, the inference information component 1060 is capable of, configured to, or operable to support a means for obtaining, in response to the one or more messages indicative of the set of consistency constraints, the set of inference information, where monitoring the ML model is in accordance with the set of inference information.

In some examples, to support monitoring the ML model, the monitoring component 1030 is capable of, configured to, or operable to support a means for monitoring the ML model using a subset of the first set of multiple data instances associated with the set of training information, where the subset of the first set of multiple data instances and the second set of multiple data instances satisfy the set of consistency constraints.

In some examples, the first set of multiple data instances and the second set of multiple data instances being in accordance with consistent parameter values includes the first set of multiple data instances being in accordance with one or more first parameter values, and the second set of multiple data instances being in accordance with one or more second parameter values, where each of the one or more first parameter values and the one or more second parameter values are within a corresponding range, each of the one or more first parameter values are within a threshold of a corresponding second parameter value from among the one or more second parameter values, or any combination thereof.

In some examples, to support monitoring the ML model, the similarity component 1065 is capable of, configured to, or operable to support a means for determining a similarity between the set of training information and the set of inference information.

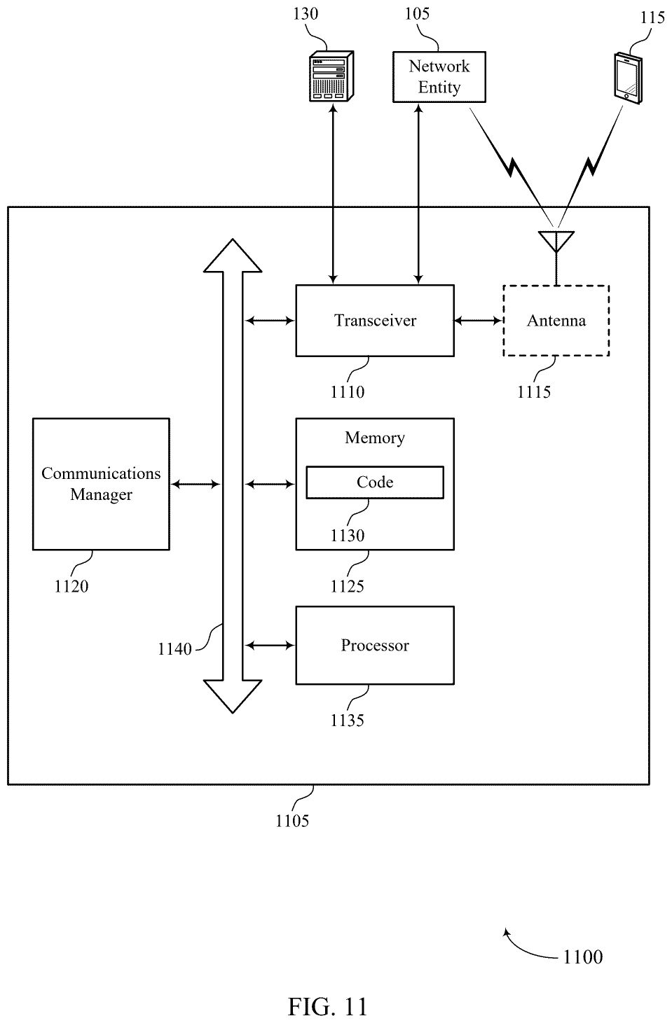

FIG. 11 shows a diagram of a system 1100 including a device 1105 that supports ML model monitoring in accordance with consistency constraints in accordance with one or more aspects of the present disclosure. The device 1105 may be an example of or include components of a device 805, a device 905, a network entity 105, or a UE 115 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting ML model monitoring in accordance with consistency constraints). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for obtaining a set of consistency constraints associated with monitoring a ML model, the ML model associated with a set of training information including a first set of multiple data instances, where the set of consistency constraints are associated with the first set of multiple data instances within the set of training information and a second set of multiple data instances within a set of inference information being in accordance with consistent parameter values. The communications manager 1120 is capable of, configured to, or operable to support a means for monitoring the ML model in response to the first set of multiple data instances and the second set of multiple data instances satisfying the set of consistency constraints. The communications manager 1120 is capable of, configured to, or operable to support a means for performing the wireless communications in accordance with monitoring the ML model.

By including or configuring the communications manager 1120 in accordance with examples as described herein, the device 1105 may support techniques for improved user experience related to reduced processing, more efficient utilization of communication resources, improved coordination between devices, and improved utilization of processing capability.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of ML model monitoring in accordance with consistency constraints as described herein, or the at least one processor 1135 and the at least one memory 1125 may be otherwise configured to, individually or collectively, perform or support such operations.

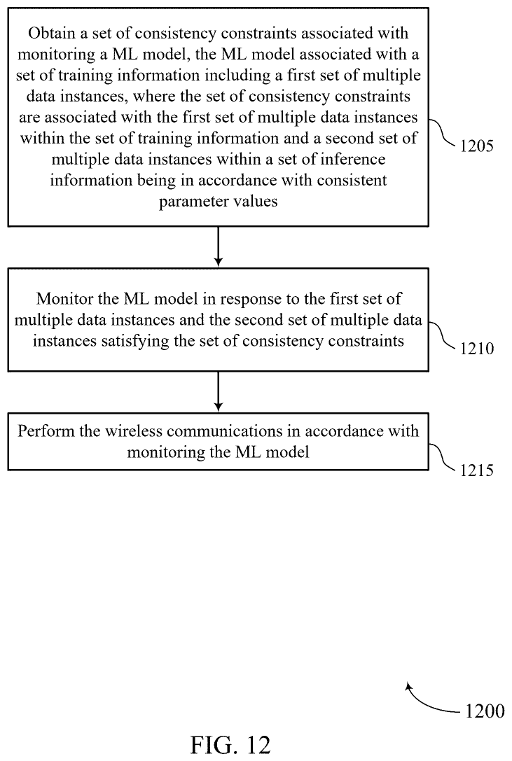

FIG. 12 shows a flowchart illustrating a method 1200 that supports ML model monitoring in accordance with consistency constraints in accordance with one or more aspects of the present disclosure. The operations of the method 1200 may be implemented by a network entity or a UE as described herein. For example, the operations of the method 1200 may be performed by a network entity or a UE as described with reference to FIGS. 1 through 11. In some examples, a network entity or a UE may execute a set of instructions to control the functional elements of the network entity to perform the described functions. Additionally, or alternatively, the network entity may perform aspects of the described functions using special-purpose hardware.

At 1205, the method may include obtaining a set of consistency constraints associated with monitoring a ML model, the ML model associated with a set of training information including a first set of multiple data instances, where the set of consistency constraints are associated with the first set of multiple data instances within the set of training information and a second set of multiple data instances within a set of inference information being in accordance with consistent parameter values. The operations of 1205 may be performed in accordance with examples as disclosed herein. In some examples, aspects of the operations of 1205 may be performed by a consistency constraint component 1025 as described with reference to FIG. 10.

At 1210, the method may include monitoring the ML model in response to the first set of multiple data instances and the second set of multiple data instances satisfying the set of consistency constraints. The operations of 1210 may be performed in accordance with examples as disclosed herein. In some examples, aspects of the operations of 1210 may be performed by a monitoring component 1030 as described with reference to FIG. 10.

At 1215, the method may include performing the wireless communications in accordance with monitoring the ML model. The operations of 1215 may be performed in accordance with examples as disclosed herein. In some examples, aspects of the operations of 1215 may be performed by a communications component 1035 as described with reference to FIG. 10.

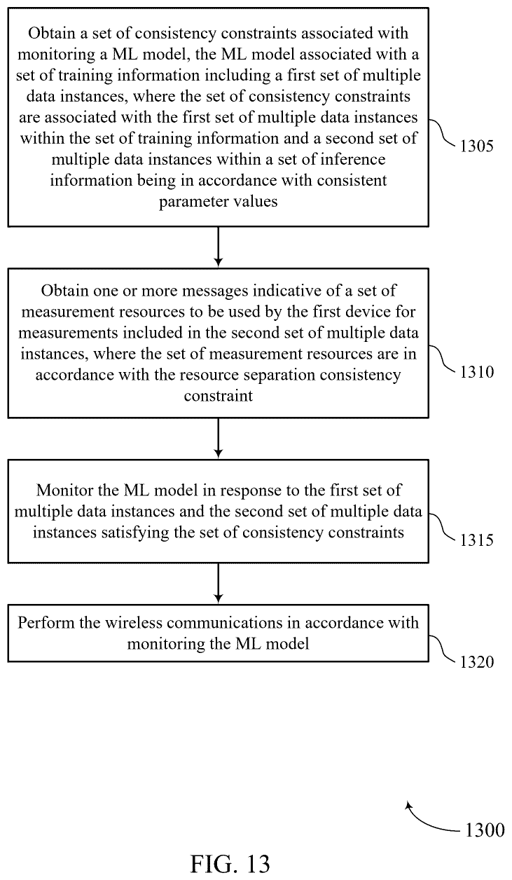

FIG. 13 shows a flowchart illustrating a method 1300 that supports ML model monitoring in accordance with consistency constraints in accordance with one or more aspects of the present disclosure. The operations of the method 1300 may be implemented by a network entity or a UE as described herein. For example, the operations of the method 1300 may be performed by a network entity or a UE as described with reference to FIGS. 1 through 11. In some examples, a network entity or a UE may execute a set of instructions to control the functional elements of the network entity to perform the described functions. Additionally, or alternatively, the network entity may perform aspects of the described functions using special-purpose hardware.

At 1305, the method may include obtaining a set of consistency constraints associated with monitoring a ML model, the ML model associated with a set of training information including a first set of multiple data instances, where the set of consistency constraints are associated with the first set of multiple data instances within the set of training information and a second set of multiple data instances within a set of inference information being in accordance with consistent parameter values. The operations of 1305 may be performed in accordance with examples as disclosed herein. In some examples, aspects of the operations of 1305 may be performed by a consistency constraint component 1025 as described with reference to FIG. 10.

At 1310, the method may include obtaining one or more messages indicative of a set of measurement resources to be used by the first device for measurements included in the second set of multiple data instances, where the set of measurement resources are in accordance with the resource separation consistency constraint. The operations of 1310 may be performed in accordance with examples as disclosed herein. In some examples, aspects of the operations of 1310 may be performed by a measurement resource component 1040 as described with reference to FIG. 10.

At 1315, the method may include monitoring the ML model in response to the first set of multiple data instances and the second set of multiple data instances satisfying the set of consistency constraints. The operations of 1315 may be performed in accordance with examples as disclosed herein. In some examples, aspects of the operations of 1315 may be performed by a monitoring component 1030 as described with reference to FIG. 10.

At 1320, the method may include performing the wireless communications in accordance with monitoring the ML model. The operations of 1320 may be performed in accordance with examples as disclosed herein. In some examples, aspects of the operations of 1320 may be performed by a communications component 1035 as described with reference to FIG. 10.

The following provides an overview of aspects of the present disclosure:

Aspect 1: A method for wireless communications at a first device, comprising: obtaining a set of consistency constraints associated with monitoring a ML model, the ML model associated with a set of training information comprising a first plurality of data instances, wherein: the set of consistency constraints are associated with the first plurality of data instances within the set of training information and a second plurality of data instances within a set of inference information being in accordance with consistent parameter values; monitoring the ML model in response to the first plurality of data instances and the second plurality of data instances satisfying the set of consistency constraints; and performing the wireless communications in accordance with monitoring the ML model.

Aspect 2: The method of aspect 1, wherein the set of consistency constraints comprises a distribution dimension consistency constraint associated with a quantity of measurements per data instance, and wherein the first plurality of data instances and the second plurality of data instances satisfying the distribution dimension consistency constraint comprises data instances within the first plurality of data instances comprising a first quantity of measurements; and data instances within the second plurality of data instances comprising the first quantity of measurements or a second quantity of measurements that is within a threshold of the first quantity of measurements.

Aspect 3: The method of any of aspects 1 through 2, wherein the set of consistency constraints comprises a resource separation consistency constraint associated with a separation within a domain between measurements included in respective data instances, wherein the domain comprises a time domain, a frequency domain, a beam direction domain, or any combination thereof, and wherein the first plurality of data instances and the second plurality of data instances satisfying the resource separation consistency constraint comprises data instances within the first plurality of data instances comprising measurements that are separated according to a first separation within the domain; and data instances within the second plurality of data instances comprising measurements that are separated according to the first separation or a second separation within the domain that is within a threshold of the first separation.

Aspect 4: The method of aspect 3, further comprising: obtaining one or more messages indicative of a set of measurement resources to be used by the first device for measurements included in the second plurality of data instances, wherein the set of measurement resources are in accordance with the resource separation consistency constraint.

Aspect 5: The method of any of aspects 1 through 4, wherein the set of consistency constraints comprises a measurement resource consistency constraint associated with a type of reference signal used for measurements included in respective data instances, and wherein the first plurality of data instances and the second plurality of data instances satisfying the measurement resource consistency constraint comprises a same type of reference signal being used for measurements included in data instances within the first plurality of data instances and for measurements included in data instances within the second plurality of data instances.

Aspect 6: The method of any of aspects 1 through 5, wherein the set of consistency constraints comprise an EPRE consistency constraint associated with an EPRE ratio between reference signals used for measurements included in respective data instances, and wherein the first plurality of data instances and the second plurality of data instances satisfying the EPRE consistency constraint comprises first reference signals for measurements included in data instances within the first plurality of data instances and second reference signals for measurements included in data instances within the second plurality of data instances being in accordance with the EPRE ratio.

Aspect 7: The method of any of aspects 1 through 6, further comprising: communicating one or more messages indicative of a set of measurement resources to be used by the first device for measurements associated with the second plurality of data instances, wherein the set of measurement resources are in accordance with the set of consistency constraints.

Aspect 8: The method of any of aspects 1 through 7, wherein obtaining the set of consistency constraints comprises: receiving one or more messages indicative of the set of consistency constraints.

Aspect 9: The method of any of aspects 1 through 8, wherein obtaining the set of consistency constraints comprises: obtaining a resource configuration associated with a quantity of measurements per data instance, a separation between measurements of data instances, a reference signal type, an EPRE ratio, or any combination thereof; and identifying the set of consistency constraints in accordance with the resource configuration.

Aspect 10: The method of aspect 9, wherein the resource configuration includes a field that indicates that the resource configuration is indicative of the set of consistency constraints.

Aspect 11: The method of any of aspects 1 through 10, wherein the ML model is associated with one or more functionalities, an identifier, or both, and wherein obtaining the set of consistency constraints comprises: obtaining the set of consistency constraints in accordance with an association between the set of consistency constraints and a functionality of the one or more functionalities, the identifier, or both.

Aspect 12: The method of any of aspects 1 through 11, wherein obtaining the set of consistency constraints comprises: outputting a capability message indicating a capability of the first device to support one or more consistency constraints; and obtaining the set of consistency constraints in accordance with the capability of the first device.

Aspect 13: The method of any of aspects 1 through 12, further comprising: outputting a recommendation associated with the set of consistency constraints, wherein the recommendation is in accordance with the set of training information.

Aspect 14: The method of any of aspects 1 through 13, further comprising: outputting one or more messages indicative of the set of consistency constraints; and obtaining, in response to the one or more messages indicative of the set of consistency constraints, the set of inference information, wherein monitoring the ML model is in accordance with the set of inference information.

Aspect 15: The method of any of aspects 1 through 14, wherein monitoring the ML model comprises: monitoring the ML model using a subset of the first plurality of data instances associated with the set of training information, wherein the subset of the first plurality of data instances and the second plurality of data instances satisfy the set of consistency constraints.

Aspect 16: The method of any of aspects 1 through 15, wherein the first plurality of data instances and the second plurality of data instances being in accordance with consistent parameter values comprises: the first plurality of data instances being in accordance with one or more first parameter values; and the second plurality of data instances being in accordance with one or more second parameter values, wherein each of the one or more first parameter values and the one or more second parameter values are within a corresponding range, each of the one or more first parameter values are within a threshold of a corresponding second parameter value from among the one or more second parameter values, or any combination thereof.

Aspect 17: The method of any of aspects 1 through 16, wherein monitoring the ML model comprises: determining a similarity between the set of training information and the set of inference information.

Aspect 18: A first device for wireless communications, comprising one or more memories storing processor-executable code, and one or more processors coupled with the one or more memories and individually or collectively operable to execute the code to cause the first device to perform a method of any of aspects 1 through 17.

Aspect 19: A first device for wireless communications, comprising at least one means for performing a method of any of aspects 1 through 17.

Aspect 20: A non-transitory computer-readable medium storing code for wireless communications, the code comprising instructions executable by one or more processors to perform a method of any of aspects 1 through 17.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions. Also, as used herein, the phrase “a set” shall be construed as including the possibility of a set with one member. That is, the phrase “a set” shall be construed in the same manner as “one or more.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first device, comprising:
one or more memories storing processor-executable code; and
one or more processors coupled with the one or more memories and individually or collectively operable to execute the code to cause the first device to:
obtain a set of consistency constraints associated with monitoring a machine learning model, the machine learning model associated with a set of training information comprising a first plurality of data instances, wherein:
the set of consistency constraints are associated with the first plurality of data instances within the set of training information and a second plurality of data instances within a set of inference information being in accordance with consistent parameter values;
monitor the machine learning model in response to the first plurality of data instances and the second plurality of data instances satisfying the set of consistency constraints; and
perform wireless communications in accordance with monitoring the machine learning model.

2. The first device of claim 1, wherein:
the set of consistency constraints comprises a distribution dimension consistency constraint associated with a quantity of measurements per data instance, and wherein the first plurality of data instances and the second plurality of data instances satisfying the distribution dimension consistency constraint comprises:
data instances within the first plurality of data instances comprising a first quantity of measurements; and
data instances within the second plurality of data instances comprising the first quantity of measurements or a second quantity of measurements that is within a threshold of the first quantity of measurements.

3. The first device of claim 1, wherein:
the set of consistency constraints comprises a resource separation consistency constraint associated with a separation within a domain between measurements included in respective data instances, wherein the domain comprises a time domain, a frequency domain, a beam direction domain, or any combination thereof, and wherein the first plurality of data instances and the second plurality of data instances satisfying the resource separation consistency constraint comprises:
data instances within the first plurality of data instances comprising measurements that are separated according to a first separation within the domain; and
data instances within the second plurality of data instances comprising measurements that are separated according to the first separation or a second separation within the domain that is within a threshold of the first separation.

4. The first device of claim 3, wherein the one or more processors are individually or collectively further operable to execute the code to cause the first device to:
obtain one or more messages indicative of a set of measurement resources to be used by the first device for measurements included in the second plurality of data instances, wherein the set of measurement resources are in accordance with the resource separation consistency constraint.

5. The first device of claim 1, wherein:
the set of consistency constraints comprises a measurement resource consistency constraint associated with a type of reference signal used for measurements included in respective data instances, and wherein the first plurality of data instances and the second plurality of data instances satisfying the measurement resource consistency constraint comprises:
a same type of reference signal being used for measurements included in data instances within the first plurality of data instances and for measurements included in data instances within the second plurality of data instances.

6. The first device of claim 1, wherein:
the set of consistency constraints comprise an energy per resource element (EPRE) consistency constraint associated with an EPRE ratio between reference signals used for measurements included in respective data instances, and wherein the first plurality of data instances and the second plurality of data instances satisfying the EPRE consistency constraint comprises:
first reference signals for measurements included in data instances within the first plurality of data instances and second reference signals for measurements included in data instances within the second plurality of data instances being in accordance with the EPRE ratio.

7. The first device of claim 1, wherein the one or more processors are individually or collectively further operable to execute the code to cause the first device to:
communicate one or more messages indicative of a set of measurement resources to be used by the first device for measurements associated with the second plurality of data instances, wherein the set of measurement resources are in accordance with the set of consistency constraints.

8. The first device of claim 1, wherein, to obtain the set of consistency constraints, the one or more processors are individually or collectively operable to execute the code to cause the first device to:
receive one or more messages indicative of the set of consistency constraints.

9. The first device of claim 1, wherein, to obtain the set of consistency constraints, the one or more processors are individually or collectively operable to execute the code to cause the first device to:
obtain a resource configuration associated with a quantity of measurements per data instance, a separation between measurements of data instances, a reference signal type, an energy per resource element (EPRE) ratio, or any combination thereof; and
identify the set of consistency constraints in accordance with the resource configuration.

10. The first device of claim 9, wherein the resource configuration includes a field that indicates that the resource configuration is indicative of the set of consistency constraints.

11. The first device of claim 1, wherein the machine learning model is associated with one or more functionalities, an identifier, or both, and wherein, to obtain the set of consistency constraints, the one or more processors are individually or collectively operable to execute the code to cause the first device to:
obtain the set of consistency constraints in accordance with an association between the set of consistency constraints and a functionality of the one or more functionalities, the identifier, or both.

12. The first device of claim 1, wherein, to obtain the set of consistency constraints, the one or more processors are individually or collectively operable to execute the code to cause the first device to:
output a capability message indicating a capability of the first device to support one or more consistency constraints; and
obtain the set of consistency constraints in accordance with the capability of the first device.

13. The first device of claim 1, wherein the one or more processors are individually or collectively further operable to execute the code to cause the first device to:
output a recommendation associated with the set of consistency constraints, wherein the recommendation is in accordance with the set of training information.

14. The first device of claim 1, wherein the one or more processors are individually or collectively further operable to execute the code to cause the first device to:
output one or more messages indicative of the set of consistency constraints; and
obtain, in response to the one or more messages indicative of the set of consistency constraints, the set of inference information, wherein monitoring the machine learning model is in accordance with the set of inference information.

15. The first device of claim 1, wherein, to monitor the machine learning model, the one or more processors are individually or collectively operable to execute the code to cause the first device to:
monitor the machine learning model using a subset of the first plurality of data instances associated with the set of training information, wherein the subset of the first plurality of data instances and the second plurality of data instances satisfy the set of consistency constraints.

16. The first device of claim 1, wherein the first plurality of data instances and the second plurality of data instances being in accordance with consistent parameter values comprises:
the first plurality of data instances being in accordance with one or more first parameter values; and
the second plurality of data instances being in accordance with one or more second parameter values, wherein each of the one or more first parameter values and the one or more second parameter values are within a corresponding range, each of the one or more first parameter values are within a threshold of a corresponding second parameter value from among the one or more second parameter values, or any combination thereof.

17. The first device of claim 1, wherein, to monitor the machine learning model, the one or more processors are individually or collectively operable to execute the code to cause the first device to:
determine a similarity between the set of training information and the set of inference information.

18. A method for wireless communications at a first device, comprising:
obtaining a set of consistency constraints associated with monitoring a machine learning model, the machine learning model associated with a set of training information comprising a first plurality of data instances, wherein:
the set of consistency constraints are associated with the first plurality of data instances within the set of training information and a second plurality of data instances within a set of inference information being in accordance with consistent parameter values;
monitoring the machine learning model in response to the first plurality of data instances and the second plurality of data instances satisfying the set of consistency constraints; and
performing the wireless communications in accordance with monitoring the machine learning model.

19. The method of claim 18, wherein:
the set of consistency constraints comprises a distribution dimension consistency constraint associated with a quantity of measurements per data instance, and wherein the first plurality of data instances and the second plurality of data instances satisfying the distribution dimension consistency constraint comprises:
data instances within the first plurality of data instances comprising a first quantity of measurements; and
data instances within the second plurality of data instances comprising the first quantity of measurements or a second quantity of measurements that is within a threshold of the first quantity of measurements.

20. A non-transitory computer-readable medium storing code for wireless communications, the code comprising instructions executable by one or more processors to:
obtain a set of consistency constraints associated with monitoring a machine learning model, the machine learning model associated with a set of training information comprising a first plurality of data instances, wherein:
the set of consistency constraints are associated with the first plurality of data instances within the set of training information and a second plurality of data instances within a set of inference information being in accordance with consistent parameter values;
monitor the machine learning model in response to the first plurality of data instances and the second plurality of data instances satisfying the set of consistency constraints; and
perform the wireless communications in accordance with monitoring the machine learning model.
